(19) United States
(12) Patent Application Publication
(10) Pub. No.: US 2026/0194967 A1
(43) Pub. Date: Jul. 9, 2026

(54) Teleportation Machine using Super A.I. and the Universe Internet

(71) Applicant: Mitchell Kwok, Honolulu, HI (US)

(72) Inventor: Mitchell Kwok, Honolulu, HI (US)

(21) Appl. No.: 19/014,252

(22) Filed: Jan. 9, 2025

(51) Int. Cl. G06F 3/01

(52) U.S. Cl. CPC G06F 3/011

(57) ABSTRACT

A method to instantly teleport digital signals or physical objects for two points in space for the entire universe. A local planet has to build a network pathway comprising linked space stations to a target planet, forming a space-bridge. AI on each space station in the network pathway has to guess the target planet's light before that light gets to the local planet. The 3-d atom mapping data is propagated from space station to space station and transferring information to and from the local planet and the target planet. This space bridge created an AI portal, and up to infinite amounts of digital data can be transported instantly, using 0 second, between both planets. On the other hand, the transport of physical objects require this space bridge, the 5 sense VR technology and global telekinesis to deliver a VR illusion that is considered real teleportation of physical objects.

### CROSS REFERENCE TO RELATED APPLICATIONS

This is a Continuation-in-Part application which claims the benefit of U.S. Ser. No. 18/814,493 filed on Aug. 24, 2024, entitled: Signalless Internet using Super intelligent robots and the A.I. Gnosis timeline, which claims a U.S. Provisional application Ser. No. 63/674,853 filed on Jul. 24, 2024, entitled: Signalless Internet using Super intelligent robots and the A.I. Gnosis timeline, which claims the benefit of U.S. Ser. No. 18/661,577 filed on May 11, 2024, entitled: Universe Internet using Super A.I. and the A.I. Gnosis Timeline, which claims a U.S. Provisional application Ser. No. 63/555,392 filed on Feb. 19, 2024, entitled: Universe Internet using Super A.I. and the A.I. Gnosis Timeline, which claims the benefit of U.S. Ser. No. 18/418,273 filed on Jan. 21, 2024, entitled: Universe Time Machine using AI god and the Universe Internet, which claims the benefit of U.S. Ser. No. 12/973,955 filed on Dec. 21, 2010, entitled: AI Time Machine, which claims the benefit of U.S. Ser. No. 12/471,382 filed on May 24, 2009, entitled: Practical Time Machine Using Dynamic Efficient Virtual And Real Robots, which claims the benefit of U.S. Provisional Application No. 61/155,113, filed on Feb. 24, 2009, which claims the benefit of U.S. Provisional Application No. 61/083,930, filed on Jul. 27, 2008, which claims the benefit of U.S. Provisional Application No. 61/080,910, filed on Jul. 15, 2008, which claims the benefit of U.S. Provisional Application No. 61/079,109, filed on Jul. 8, 2008, which claims the benefit of U.S. Provisional Application No. 61/077,178, filed on Jul. 1, 2008, which claims the benefit of U.S. Provisional Application No. 61/074,634, filed on Jun. 22, 2008, which claims the benefit of U.S. Provisional Application No. 61/073,256, filed on Jun. 17, 2008, which claims the benefit of U.S. Provisional Application No. 61/053,334, filed on May 15, 2008, which is a Continuation-in-Part application of U.S. Ser. No. 12/135,132, filed on Jun. 6, 2008, entitled: Time Machine Software, which claims the benefit of U.S. Provisional Application No. 61/042,733, filed on Apr. 5, 2008, this application is also a Continuation-in-Part application of U.S. Ser. No. 12/129,231, filed on May 29, 2008, entitled: Human Artificial Intelligence Machine, which claims the benefit of U.S. Provisional Application No. 61/035,645, filed on Mar. 11, 2008, which is a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

### 1. Field of the Invention

This invention relates generally to the field of teleportation powered by artificial intelligence. The teleportation machine doesn't use wormholes, nor quantum entanglement, superposition and quantum telecommunications. In its stead, it uses peer to peer networks of hierarchically structured computers and celltowers to propagate signalless data transmissions called implied data transmissions, which are represented as visual cues residing in each computers's 3-d atom mapping radius.

The present invention is a real teleportation machine that allows instant transport, using 0 second, of digital data and physical objects for all planets in the Universe.

Teleportation has been the biggest sought out “science fiction” technology in movies, novels and comic books. Movies like the Fly, Masters of the Universe, Willy Wonka and the chocolate factory, Event horizon, the Transformers, The Power Rangers, Stargate, Star Trek, they all have their own teleportation machines and they all function the same way. One in particular that peek my interest is in the Masters of the Universe movie where a teleporting device called the Cosmic key has the ability to transport people anywhere in the Universe—it creates an artificial portal that allows an object/s to be teleported from one point in the Universe to another, instantaneously.

What is presented here, in this patent application, is the world's first teleportation machine. It is built on top of my previous invention, the signalless internet (aka the Universe internet). At small scale, it works in a network system in a home using our current computers today (I tested this signalless internet myself). The setup is 4 computers in a home, each located in various rooms and each computer is sending 2 bytes of information, and they are done using a signalless network of computers. This simple signalless internet works.

The Network of computers are located in different rooms and uses a 3-d atom mapping technology to read implied digital transmissions from nearby computers. It can only read 2 bytes of information at a given time. The 2 bytes (or 16-bits) are drawn on a piece of paper taped onto a computer's harddrive. Using a camera mounted on a computer, it's AI is able to read the 2 bytes of its neighbor computer using x-ray vision, heat signature or video filtering software. Furthermore, each computer is located in a unique room with a locked door—each computer can't see each other. This is why AI is needed to take the images of each computer's camera to see through walls and read the 2 bytes from a nearby computer's harddrive. The propagation of implied data transmission is tested too, and each computer is able to relay implied data transmissions to nearby computers in this peer to peer network.

Scaling would include increasing the data transmission and increasing the distances of the computers. I'm certain the scaling problem is no issue at all, and the present invention called the Signalless internet is implementable in the real world—first for a city, a continent, a planet, a solar system, a galaxy and finally the entire Universe. By combining other components, the signalless internet is used to teleport physical objects and digital data anywhere in the Universe.

One more thing, this type of teleportation is for all planets in the Universe and not just localized to space in one planet. It was designed to teleport objects lightyears between two points in the Universe.

This teleportation machine is an interlocking combination of inventions previously filed by Mitchell Kwok, such as the Universe internet, the Atom manipulator, AI god, global telekinesis, Robot superheroes, the 5 sense VR technology, the Signalless internet, Super AI, Super intelligent robots and Human level AI. Over 100 unique inventions, all built on top of each other, were invented by Mitchell Kwok since 2006. It's the combination of these inventions that allow this teleportation machine to be realized.

### 2. Description of Related Art

### SUMMARY OF THE INVENTION

From Pluto it takes approximately 5 hours for a digital signal (or streams of photons) to travel at the speed of light to get to Earth, and vice versa. Using AI teleportation and creating an artificial portal, the digital data from Pluto can get to Earth in 0 second (or no time). The digital data is teleported from Earth to the target area, which is Pluto, instantaneously. The amount of data to be transported can be “infinite.” Yes, you heard me right, the data transmittal can be infinite data to be sent from Earth to Pluto and done in 0 second. That's how fast this Signalless internet is. It's infinitely fasterthanlight telecommunications, and in actuality is a 0 second telecommunication system that spans the entire Universe.

What is even more remarkable and inexplicable is the fact that the distance between planets can be anything. It can be 90 billion lightyears apart and still the AI teleportation of infinite digital data can be transmitted instantaneously, in 0 second.

Let me define what infinite digital data looks like. The goal of the AI is to collect all the light coming from Pluto for the current state. This light will give clues to all atom locations on Pluto (this is a 3-d atom mapping technology). The AI is trying to predict the precise locations of every atom, electron, and em radiation on Pluto so that all of its computers and networks comprising Pluto's internet can be read for its current state. Specifically, Earth's AI wants to read the data in each computer's harddrive. The data transmittal from Pluto to Earth are stored in these harddrives. If the AI can read all the computers in Pluto's internet, the data transmission can be large, like in the 70 trillion petabytes of information. Instead of transmitting one bit at a time in the air to Pluto, Earth's AI can just map out every atom on Pluto and Earth's AI can capture all 70 trillion petabytes of digital information; using just one pass.

By tracking all the current atoms and their respective sub-atomic particles on Pluto, Earth's AI can see all of Pluto's activities on the planet especially its internet activities. Earth's AI will know who the senders and receivers are over Pluto's entire internet. If user2 from Pluto wants to send a message to user5 on Earth, Earth's AI will identify this current activity happening on Pluto's surface and respond immediately by delivering the message to user5 on Earth. The AI is responsible for delivering all messages coming from Pluto to individual users on Earth, and identifying Earth users and sending their messages to Pluto.

Earth's AI uses this AI teleportation to create a space bridge between Earth and Pluto so that the two planets co-exist in the same current time and space. Now, in this synchronized current state, both planets can communicate with each other in real time using a planetary internet. This space bridge creates an artificial portal that can transmit digital data or physical objects in 0 second between the two planets.

This method is infinitely faster than 5G telecommunications because 5G uses wifi signals in the air. My AI teleportation is signalless and instead uses a 3-d atom mapping technology to read nearby computers. The network works exactly like our internet, but it's signalless and the data transmissions are based on implied data transmissions stored in harddrives of nearby computers. The network propagates implied data transmissions from computer to computer to get messages from a sender to a receiver.

Referring to FIG. 1, an artificial portal is created between Earth and Pluto. Within the AI portal is a space bridge that comprises a network of space stations (each space station is a computer). Signalless telecommunications is used here to propagate implied data transmissions from computer to computer. Each computer in the network is reading nearby transmissions through a 3-d atom mapping technology powered by AI. Each computer has cameras and sensors in 360 degrees collecting primarily light to generate a 360 degree atom map of its immediate environment. Once the 3-d atom map is generated, it zeroes in on nearby computers, specifically its harddrive data, to read and transmit digital data. Transmission data and their respective routing paths are outlined in each computer, and each nearby computer has to work together to relay digital data back and forth in the network. For example, computer4 sends an implied message to computer5 and computer5 sends the implied message to computer6. Each computer will update its transmission list and digital data are propagated from computer to computer in the network until it reaches its destination.

In my design, the space stations in the space bridge relays data transmissions and the propagation takes 0 second to reach Earth from Pluto. The telecommunications data are implied through a 3-d atom mapping technology and is signalless. This means there won't be digital signal interruptions and all internet users are always connected, 24/7.

The boundaries of the Universe internet, centered on Earth, is limited to the radius of how much distributed space stations are sent outside of Earth. We have to treat space coverage like cellphone coverage, every square inch of the Universe must be covered. Obviously, we have to use holistics to put more space stations in areas that require the most usage.

The boundaries of the Universe internet should have instant communications with any space territory that it reaches, especially planets, satellites and artificial stations. Everything is signalless, all the computers in the network are signalless and even the peripheral devices like smartphones, printers, wearable devices, scanners, cameras and so on, are all signalless and doesn't require sending digital signals in the air for communication.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a diagram depicting the interconnected nodes of space stations, which forms a space bridge between Earth and Pluto. The head node is Earth and the end node is Pluto creating an AI portal between the two planets, Earth and Pluto.

FIG. 2 is a diagram depicting the hierarchically structured Celltowers and individual computers to relay implied transmission data from computer to computer in a signalless internet. This signalless internet is applied to planets in our Universe.

FIG. 3 is a diagram depicting a rerouting method in case a node in the network pathway between two planets is broken.

FIG. 4 is a diagram depicting usage of celltowers to relay messages for long distant communications.

FIG. 5 is a diagram depicting The time it takes for light from Pluto to reach Earth, and what part of space between the two planets are affected.

FIG. 6 is a diagram depicting the interconnected nodes (individual computers and celltowers) for a signalless internet for a city.

FIG. 7 is a diagram depicting the parts of an individual computer. It shows the mapping harddrive and the computer harddrive and their locations on a physical computer.

FIG. 8 is a diagram depicting in great details the mapping harddrive and the data transmission list, which contains a list of transmission data and their respective routing paths.

FIG. 9 is a diagram depicting what static data transmission looks like. All transmission data are stored as 0s and 1s on a computer's harddrive. The AI has to map out all the atoms in a computer's harddrive to read all the static data, using one pass.

FIG. 10 is a diagram depicting sequential data transmissions using one Christmas light bulb. A 0 is transmitted when the light bulb is turned off and a 1 is transmitted when the light bulb is turned on. The light bulb is flashing on and off to transmit digital signals and affecting all objects in its surroundings.

FIG. 11 is a diagram depicting the distance between computer_R1 and computer_D2, whereby computer_R1 is located in one home and computer_D2 is located in another home 5 miles away.

FIG. 12 is a diagram depicting a plurality of Christmas lights, located in spaced out areas, flashing on and off to transmit parallel sequential data transmissions.

FIG. 13 is a diagram showing the configuration of a computer's harddrive whereby at the top are big bits and at the bottom are small bits.

FIG. 14 is a diagram depicting an example of low frequency wifi, localized to a small area on Earth that can be read on Mars using AI.

FIG. 15 is a diagram showing the Universe timeline has a master clock, despite the fact that different space has different time. The surface plane shows different space has different time and each object or event in space has associated links to the Universe timeline.

FIG. 16 is a diagram depicting the acceleration of objects and how it affects its time speed. The fastest speed for an object is light speed, which is represented by 1, and the slowest speed is 0 when the object is stationary.

FIG. 17 is a diagram depicting a specie's perception of the speed of objects in its surroundings. This is primarily for robots whereby it speeds up its brain and body to experience time dilation or slowing of objects in its surroundings. It also shows the hidden time dimension.

FIG. 18 is a diagram depicting a space bridge1 between Earth and Malaxy, and the added space bridge7 between Earth and Planto. Each space bridge has a reinforced territory radius that gives Earth the ability to view all objects (planets) in a space territory.

### DESCRIPTION OF THE PREFERRED EMBODIMENTS

Here is the outline to this patent application: 1. AI teleportation. 2. Static data transmission vs. Sequential data transmission. 3. Review of the Signalless internet (aka the Universe internet). 4. Other topics: Robot superheroes—AI ice and AI fire. 5. AI relativity and the Master clock. 6. Robot and Human immortality.

### AI Teleportation

From Pluto it takes about 5 hours for a digital signal (or streams of photons) to travel at the speed of light to get to Earth, and vice versa. Using AI teleportation and creating an artificial portal, the digital data from Pluto can get to Earth in 0 second (or no time). The digital data is teleported from Earth to the target area, which is Pluto, instantaneously. The amount of data to be transported can be “infinite.” Yes, you heard me right, the data transmittal can be infinite data to be sent from Earth to Pluto and done in 0 second. That's how fast this Signalless internet is.

What is even more remarkable and inexplicable is the fact that the distance between planets can be anything. It can be 90 billion lightyears apart and still the AI teleportation of infinite digital data can be transmitted instantaneously, in 0 second.

Let me define what infinite digital data looks like. The goal of the AI is to collect all the light coming from Pluto for the current state. This light will give clues to all atom locations on Pluto (this is a 3-d atom mapping technology). The AI is trying to predict the precise locations of every atom, electron, and em radiation on Pluto so that all of its computers and networks comprising Pluto's internet can be read for its current state. Specifically, Earth's AI wants to read the data in each computer's harddrive. The data transmittal from Pluto to Earth are stored in these harddrives. If the AI can read all the computers in Pluto's internet, the data transmittal can be large, like in the 70 trillion petabytes of information. Instead of transmitting one bit at a time in the air to Pluto, Earth's AI can just map out every atom on Pluto and Earth's AI can capture all 70 trillion petabytes of digital information; using just one pass.

By tracking all the current atoms and their respective sub-atomic particles on Pluto, Earth's AI can see all of Pluto's activities on the planet especially its internet activities. Earth's AI will know who the senders are and who the receivers are over Pluto's entire internet. If user2 from Pluto wants to send a message to user5 on Earth, Earth's AI will identify this current activity on Pluto's surface and respond immediately by delivering the message to user5 on Earth.

Earth's AI uses this AI teleportation to create a space bridge between Earth and Pluto so that the two planets co-exist in the same current time and space. Now, in this synchronized current state, both planets can communicate with each other in real time using a planetary internet. This artificial portal can transmit digital data or physical objects in 0 second.

This method is infinitely faster than 5G telecommunications because 5G uses wifi signals in the air. My AI teleportation is signalless and instead uses a 3-d atom mapping technology to read nearby computers. The network works exactly like our internet, but it's signalless and the data transmissions are based on implied data transmissions stored in harddrives of nearby computers. The network propagates implied data transmissions from computer to computer to get messages from a sender to a receiver.

A method for real teleportation of physical objects and signalless data transmissions using 0 second for all planets in the Universe, comprising: a universe internet, an AI god, a space bridge between a local planet and a target planet and utilizing global telekinesis on both said local planet and target planet.

Referring to FIG. 1, an artificial portal is created between Earth and Pluto. Within the AI portal is a space bridge that comprises a network of space stations (each space station is a computer). Signalless telecomminications is used here to propagate implied data transmissions from computer to computer. Each computer in the network is reading nearby transmissions through a 3-d atom mapping technology powered by AI. Each computer has cameras and sensors in 360 degrees, collecting primarily light to generate a 360 degree atom map of its immediate environment. Once the 3-d atom map is generated it zeroes in on nearby computers, specifically its harddrive data, to read and transmit digital data. Transmission data and their respective routing paths are outlined in each computer, and each nearby computer has to work together to relay digital data back and forth in the network. For example, computer4 sends an implied message to computer5 and computer5 sends the implied message to computer6. Each computer will update its transmission list and digital data are propagated from computer to computer in the network until it reaches its destination.

In my design, the space stations in the space bridge relays data transmissions and the propagation takes 0 second to reach Earth from Pluto. The telecommunications are implied through a 3-d atom mapping technology and is signalless. This means there won't be digital signal interruptions and all internet users are always connected, 24/7.

The boundaries of the Universe internet, centered on Earth, is limited to the radius of how much distributed space stations are sent outside of Earth. We have to treat space coverage like cellphone coverage, every square inch of the Universe must be covered. Obviously, we have to use holistics to put more space stations in areas that require the most usage.

The boundaries of the Universe internet should have instant communications with any space territory that it reaches, especially planets, satellites and artificial stations. Everything is signalless, all the computers in the network are signalless and even the peripheral devices like smartphones, printers, desktop systems, wearable devices, scanners, cameras and so on, are all signalless and doesn't require sending digital signals in the air for communication.

The fact that in the history of Nasa no scientist has ever discovered any artificial structure in outer-space tells me that the human race seems to be the only civilization that exists in this part of the galaxy. I am not surprised that no alien digital signals were ever discovered by Earth scientists. It's because an advance civilization doesn't use digital signals for communications. All alien planets in the Universe have a signalless internet in order to do instant communications. This will tell you what will happen to 5G and 6G telecommunications in the future. They will be replaced with a signalless internet in its stead. It's the same internet, but the network system and functions are different.

This is good news for the human race and for Earth. We can use this opportunity to expand the human race throughout the galaxies and colonize as much planets as possible, or to build artificial planets.

This is a golden opportunity for humanity to dominate this entire galaxy and nearby galaxies. We need to expand our human civilization and to build as much AI planets as possible. This will ensure the human race's salvation. The more planets we colonize or build, the stronger we become. We'll need this military might when we encounter another alien species in “first contact.”

The first step is to build this Universe internet, and from there we keep expanding our space territories. For each planet we colonize or artificially create, we have to build space bridges between planets so these newly created planets can be part of the Universe internet. The more planets we build, the larger our network of planets become.. and the more money we will make. These structured networks of planets are part of an interconnected e-commerce, and planets lightyears apart can buy and sell products and services to each other, or share information. Like I said before, the amount of money to be made from Super AI is infinite. We, the people of Earth, can make infinite amounts of money with Super AI by applying it to AI planets and interplanetary e-commerce. Each planet that we create is worth equal to or more than the Earth itself. Planet Earth will be paid passive money with every artificial planet we build. All the planets connected to the Universe internet will be paying Earth because we invented the Universe internet and we invented this interplanetary e-commerce.

For really long distances, like planets in a solar system or planets in a galaxy, celltowers are needed, and a celltower is just a computer that collects and relay information for large groups of space stations. These celltowers and individual computers are equally distributed throughout the galaxies, and both the celltowers and individual computers are hierarchically structured in a network of trees and forests, connected or not connected.

An added advantage over 5G telecommunications is that you can have any amount of users or peripheral devices connected for one household. For example, you can have 4 billion peripheral devices connected to a single computer, and that computer and all of its devices can be connected to the internet. It's signalless and each electronic device isn't transmitting signals in the air, so a user can have as many devices connected over the internet. This signalless internet can handle 50 trillion computers per house for all houses on a planet. In contrast, 5G has to isolate all these signals coming from different computers and send each one to the nearby celltowers. If you have lots of signals in one small area, the celltowers won't be able to handle the load due to frequency interference.

### Connecting with Alien Planets

Earth can expand its Universe internet one planet at a time, or one solar system at a time, or one galaxy at a time. For space territories claimed by aliens, we can connect to their network of computers. Compatibility is no issue because AI translates their internet protocols, and all computers in the universe uses Boolean algebra and discrete math. The aliens can use our network computers and conversely we can use their network computers. As more alien civilizations connect their planetary internets, the universe internet gets bigger and bigger and the money in the interplanetary e-commerce gets larger and larger. This goes on and on until the entire universe is united under a single internet. All the knowledge in the universe, from all planets, spanning 93 billion light years, resides in this universe internet.

### A Master Clock

The first thing that is needed for a Universe internet is a master clock to synchronize all time for all planets in the Universe, permitting interplanetary communications. According to Einstein, he said there is no master clock and that time is different for different space. Einstein also stated that time is slightly different for the movement of objects. For instance, a person traveling in a ship moving at the speed of light will experience accelerated time (inside the ship), while a person outside the ship is stationary and will experience normal time. Accelerated time means the ship is traveling into the future. Gravitational distortions is also a factor that warps time and space and causes time distortions, resulting in different time speeds.

I published an issue in the Super AI comic book with the sub-title: AI relativity, which describes an updated version of Einstein's relativity equations/theories and applied it to modern AI and robotics. For the most part Einstein was right about different space have different time and therefore there is no master clock for everyone in the Universe. However, he was applying his relativity equations to humans. If you look at his equations in terms of robots, his theories are wrong. For robots there is one master clock that govern all robots in the Universe regardless of their distance apart.

A robot with human level AI has the ability to accelerate its brain and body. I call it a super intelligent robot or a superhuman robot. By accelerating its digital human brain, the robot can experience time differently—it can experience time faster than normal or slower than normal. In normal time, a robot has human level AI and is experiencing time just like a human being. Some robots are moving fast and they experience time slightly faster than a stationary robot. In order to synchronize both the stationary robot and the lightspeed robot, the robot that is moving at the speed of light has to accelerate its brain exponentially—it has to sense, think, and act exponentially faster than normal. The robot traveling at the speed of light, by speeding up its brain and body, is now able to synchronize its brain with a stationary robot's brain. Thus, the light speed moving robot can communicate with the stationary robot in real time, despite different time speeds—meaning, the time clock for both the lightspeed moving robot and the stationary robot are now synchronized.

Just for clarity, the robot traveling in a ship at lightspeed is experiencing accelerated time and is traveling into the future. When the robot is speeding up its brain and body, it is experiencing deceleration. 1 second in normal time is like 1 hour to the robot (20 hours if it thinks faster). It is this ability to decelerate and accelerate time that allow these robots to synchronize their time speeds with other robots that have different time speeds, and through this synchronization, form one master clock.

This master clock allows all robots on all planets in the Universe to communicate with each other in real time. This is not true for humans. Due to gravitational forces and acceleration of objects, humans will experience slightly different time depending on their location in the Universe. However, with this said, if we remove gravitational forces and people moving really fast in space, and all organic life in the Universe are stationary, all organic life-forms in the universe has the same master clock, and they are experiencing life with the same time speed.

So a Universe internet for humans or organic life is possible, and there is a master clock for both humans and robots alike. The Universe internet is defined by Mitchell Kwok in around 2008 as a telecommunication system for all planets in the entire Universe—spanning 93 billion lightyears in diameter. Users (robots or humans) can communicate with each other in real time (with no interruptions) and do things like surf the Universe web, do e-commerce, download large files (download trillions of gigabytes of information in 0 second from planets lightyears away from Earth), stream live events from anywhere in the Universe, etc.

The most important thing is the “master clock” for the Universe. Without this master clock, it is not possible for a Universe internet. But as you can see, I have solved this problem above. Robots can compensate for different space/time speeds by accelerating their brains and bodies, and humans have to stay stationary and away from strong gravitational forces.

The only thing I see that poses a problem for this Universe internet is if a human is traveling in a ship with lightspeed or beyond while using the Universe internet. This problem can easily be solved. All the human has to do is stop the ship, and then, use the Universe internet. After you're done using the Universe internet, you can get back into your ship and continue traveling at lightspeed. Only robots can travel at lightspeed and simultaneously surf the Universe internet. All these robots have to do is accelerate their brains to compensate for the time speed difference.

Another problem that I see that poses a direct threat to this Universe internet is what I refer to as the “lightyear problem”, which I will be talking about in the next section.

### The Lightyear Problem

Light travels at 299,792,458 meters per second—that's equivalent to 10 laps around the Earth in less than 1 second. Real time telecommunications on Earth is no problem due to the fact that digital signals travel at the speed of light from celltowers to computers to satellites in the network. However, this lightspeed telecommunications isn't fast enough for interplanetary telecommunications. For example, an internet between Earth and Pluto is impossible because there is a delay of 5 hours for each data transmission. Even if there is a direct signal traveling at lightspeed sent from Pluto, it would take 5 hours just to reach Earth, and vice versa. A short two way communication between the two planets would take 10 hours. Pluto would send a digital transmission to Earth, which will take 5 hours just to get there, and Pluto would have to wait another 5 hours just to get a response back from Earth. It would take years just to get a decent conversation in a chat room for 2 users from Earth and Pluto.

What we want is instant communication with Pluto, or with other planets lightyears away. The ideal is to create a Universe internet that spans the entire seeable Universe, which encompasses a diameter of 93 billion lightyears of space territory. The desired technology is to build a Universe internet that would allow two planets 90 billion lightyears apart to communicate with each other in real-time.

In fact, I want to be bolder and say that I want to build a Universe internet that can not only have instant communication with planets in the seeable Universe, but also the unseeable Universe. Some planets in the outer reaches of the Universe are so far away, and along with the fact that all space in the Universe is expanding, prevents even their light from reaching Earth. That's why we can't see the outer limits of the Universe (called the unseeable Universe).

A lot of people don't understand this but I Mitchell Kwok invented the technology way back in 2008. I solved this interplanetary telecommunication 17 years ago and written countless patent applications and books on the subject matter. The original name given was the Signalless internet. I was designing Super AI when I accidentally discovered this new technology. A complete patent was supposed to be filed on 2010 right after my AI time machine patent, but unfortunately for me I ran out of money. In its stead I published a book and did some instructional videos on the invention. It wasn't until years later that I filed full and comprehensive patents on the Universe Internet and the Universe time machine.

There were some obstacles that I wasn't able to overcome, or have not thoroughly gone into the details of how certain components of the Universe internet work. One of the challenging problems was solving the lightyear problem. For many years I have contemplated the lightyear problem and pondered wither it is even possible to solve.

After over a decade researching this, I am 100% certain it is possible and I have no doubt in my mind that the lightyear problem is solvable. It was solved in my patents a long time ago, I wasn't even aware that I solved it.

It was AI, Artificial intelligence, that allowed me to solve the problem.

Here is what I wanted to do, Pluto's light takes 5 hours just to get to Earth. What I want is Pluto's light to get here (on Earth) in 0 second. What I need is a method or means to make Pluto's light get here as if Earth and Pluto were the same planet, occupying the same space. In other words, I have to speed up the light and force Pluto's light to travel infinitely faster than the speed of light. The same thing is said for a planet that is 90 billion lightyears from Earth, I want that alien planet's light to get here on Earth in 0 second, instantly.

I think in Star Trek they called it fasterthanlight telecommunications. But these writers were using imagination, and technologies described in Star Trek are often times not based on real science. What they proposed in the Star Trek show is not possible due to Einstein's relativity laws. Another idea they used is wormholes. But wormholes are unproven theories and no one really knows what's on the other side of a wormhole or how it works. These writers thought wormholes are a natural means of teleportation and propose ways to create an artificial wormhole and somehow predefine its destination point. Creating an artificial wormhole is also theoretical and has not yet been proven by science. I call it, “pure science fiction.”

### The Solving of the Lightyear Problem

A network of planets and space stations—this is a traditional method proposed by various scientists to create a planetary telecommunication system. Digital signals are sent from Earth to linked space stations until it gets to the destination location. Over the years they modified this network topology to include artificial wormholes like those depicted in the Marvel Universe or Star Trek. But artificial worm holes are fictitious and not implementable in the real world. So scientists rely on digital signals that travel at lightspeed to send messages to planets, which, of course, doesn't work for interstellar telecommunications.

Still, even with this network of telecommunications, digital signals have to travel from space station to space station to get to its destination. In fact, this network design is slower because each stop, each space station, is a bump on the road and it slows down the transmission speed significantly. A direct path to the destination will be ideal and the fastest way to send a digital signal to a destination planet.

If you apply this design to Earth and Pluto, it would take longer than 5 hours to get a one way signal to either planet. Another problem is that there might be obstacles that would block the digital transmission, preventing it from reaching its destination area like asteroid belts, solar flares, gravitational forces and space debris. A really strong and precise laser is needed to send a digital signal that far away.

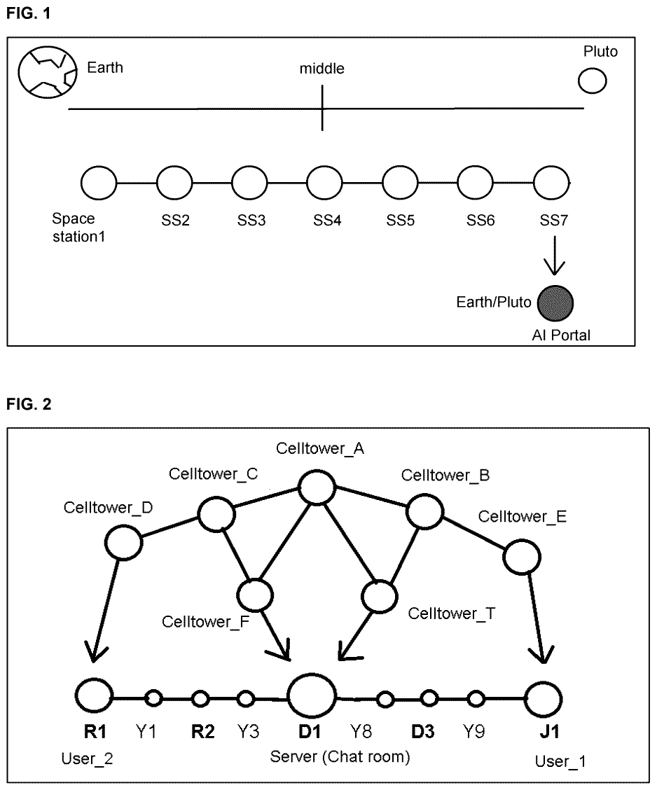

Referring to FIG. 2, this is a typical design to a network structure of space stations. It looks like the traditional space telecommunication system depicted in Star Trek, but the one difference, and in which is important, is that my network system doesn't transmit any digital signals—it doesn't stream digital packets in the air to be re-assembled in the destination location. My telecommunication system is completely signalless, and in its stead, uses a 3-d atom mapping system to read digital data from computers, specifically it reads the digital storage area in a computer's harddrive. Every grove up and down in a harddrive to represent digital bits are identified, and within a nearby computer's harddrive is the implied transmission data from a user.

The novel idea is that the transfer of digital data is done with one pass. If a sender computer wants to send 10 terabytes of information to a receiver computer, the receiver computer only has to rely on the 3-d atom mapping technology to read all the data in the sender computer's harddrive using one pass. Conventional computers send every bit as streaming digital packets in the air one at a time to a receiver computer. If you use my method, all 10 terrabytes of information can be transported from one computer to the other using just one pass, and no streaming digital packets in the air are needed for transmission.

If you want 50 trillion terabytes of information to be sent, all you need is a bigger harddrive or a thousand harddrives located close to each other. This is why I say that any amount of data transmissions can be transferred from one computer to the next in 0 second. It is due to the fact that there are no data signals transmitted in the air. This is infinitely faster than 5G and the yet to be released 6G and even 100G telecommunications. Transferring 50 trillion terabytes in 0 second between two planets 90 billion lightyears apart is the fastest internet speed anyone can design.

If you apply this method to a network of computers or the internet, you can see how this technology—this signalless internet—will replace 5G or 6G telecommunications in the future. It will provide the fastest internet speeds in the Universe, and no planet or advance alien civilization can design a faster internet.

To get a better illustration of my Universe internet, let's use a simple example. Let's imagine we wanted an internet between Earth and Pluto, how do we start? First we have to look at the Universe as one living network of atoms and photons interacting with each other, especially photons interacting with individual atoms and other photons in this Universe network.

It takes about 5 hours to get a signal to Earth from Pluto. Let's divide the distance between Earth and Pluto. In the middle is 2.5 hours, when the light from Pluto touches the middle area it interacted with all the atoms and photons in that space. Using AI, it is possible to predict half way to 2.5 hours ago on Pluto because at the middle, the light coming from Pluto 5 hours ago is interacting with the atoms and photons in the middle space. All the AI has to do is predict the middle space and because the middle space already has Pluto's light interactions, the AI is able to predict Pluto's atom state at 2.5 hours ago instead of 5 hours ago.

Referring to FIG. 1, the first half of the distance is predictable by AI when Pluto's light touches the middle space. However, the second half of the distance is still unknown and the AI can't predict this area.

This method is the key to how implied data transmissions is faster than conventional data transmissions (5G). Pluto sends natural light to Earth and it takes 5 hours to get to Earth. But, at the halfway point, Pluto's light is interacting with the middle space between Earth and Pluto, and the AI is able to predict that light coming from Pluto at the half way point. This means the AI is able to predict the light coming from Pluto 2.5 hours ago instead of 5 hours ago. This is an implementable method that sends digital signals “infinitely faster” than the speed of light (5G, wifi, lasers or radiowaves). “The AI is predicting Pluto's light before Pluto's light reaches Earth.”

Imagine that located in the middle is a space station (SS4), and this space station serves as a celltower between Earth and Pluto. The space station (SS4) has to do the same thing Earth is doing, which is to predict the current atom state of Pluto from its present location—it is trying to predict all the atoms on Pluto and to see all of its activities currently happening on the planet. The distance from the space station4 and Pluto is 2.5 hours. We have to half that and apply the previous method. The AI on SS4 has to predict the middle space residing between space station (SS4) and Pluto. Now the middle Space station (SS4) can see Pluto at 1.2 hours ago instead of 2.5 hours ago.

FIG. 1 is a diagram depicting more equally distributed space stations between Earth and Pluto. Space station_6 is now 70 minutes ago from Pluto. Thus, the AI is able to predict the missing data area and lesson the time to Pluto. As more space stations are added to the network pathway, the time distance to Pluto will lesson until it gets to 0, which is the current atom state of Pluto.

Let's go back to FIG. 1, when Earth's AI predicts the half way point, which is space station4 (SS4), it was able to map out all the atoms, electrons and em radiations from Space station4. This means it can see everything that Space station4's AI did on its 3-d atom mapping radius of its distance to Pluto. In other words, the AI on Earth when it predicts space station4 is able to read all of its harddrive data of its 3-d atom map of the distance between space station4 and Pluto.

FIG. 1 depicts the network pathway between Earth and Pluto for implied data transmissions between the two planets. Earth maps out all the atoms of space station1, station1 is mapping out all the atoms of station2, then station2 is mapping out all the atoms of station3, station3 is mapping out all the atoms of station4, next station4 is mapping out all the atoms of station5 . . . and so forth, and finally station7 is mapping out all the atoms of Pluto.

Each station in the network pathway is encapsulated in its previous node. For example, station7 is encapsulated in station6, station6 is encapsulated in station5, station5 is encapsulated in station4, station4 is encapsulated in station3, station3 is encapsulated in station2, and finally station2 is encapsulated in station1. When Earth predicts all the atoms of station1, all of its harddrive data is readable by Earth's AI. Meaning when Earth reads station1's harddrive, its harddrive contains the current state of all the encapsulated stations in the entire network pathway. When Earth reads the harddrive of station1, it can see the current states of station1-station7, and station7 contains, in its harddrive, the current atom state of Pluto.

This method is faster than lightspeed data transmission in the air (ex. 5G and 6G telecommunications). AI is used to guess the halfway point of each space station and allow Earth to see Pluto's current state, which permits an internet between Earth and Pluto with instant communication in real time. The data transmission is infinite data transmissions in 0 second between Earth and Pluto. Just to illustrate this point, using lightspeed digital transmission or 5G transmission, it takes 5 hours to get a few bits of information from Pluto to Earth. However, with my Signalless internet, at the current state for both planets, at the moment Pluto sends 50 trillion terabytes of data to Earth, Earth received all 50 trillion terabytes of data. The transmission from Earth to Pluto occurred in 0 second (0 second means anything that is less than 1 second). This is why Mitchell Kwok's Signalless internet will replace the outdated 5G telecommunication system and the yet to be released 6G telecommunication system.

The rational behind this is that Earth has the current state of all atoms of Pluto and therefore all the computers comprising Pluto's internet is visible, including all of their network computer's harddrive contents. Hence, all the content over Pluto's internet can be transferred from Pluto to Earth in 0 second (the whole thing, in one pass). The atom mapping of Pluto specially its internet is updated in real time. In other words, if you got 50 million gigabytes of information Pluto wants to transfer over to Earth, it can be done in 0 second. All Pluto has to do is store all the transmission data in their computers'harddrives marked as data shipped to Earth. The capacity of data transmission to Earth is limited to all of Pluto's computers over their internet. Data transmission isn't streaming to Earth in linear digital packets and reassembled on Earth, it is all stored in Pluto's internet (inside each computer's harddrive/s). With one pass Earth can predict all the atoms on Pluto and read all the data transmission all at once.

Some people might ask: how come your signalless internet takes 0 second to send 5,000 terabytes of information and it takes 2 years for 5G to send the same amount of information? It's because with 5G transmissions each bit has to be sent in the air from sender to receiver and the longer the distance between the sender and receive, the longer the data will take to get there. The signalless internet is a 3-d atom mapping technology and it reads computer harddrives in the network and doesn't send any digital signals in the air. The transmission data is stored conveniently in computer harddrives in the network. Each computer is mapping out the atoms in its surroundings and reading their neighbor computer's harddrive, and this collaboration is transferring information from computer to computer in the network.

### Artificial Space Bridge

To look at it another way, the network pathway between Earth and Pluto is like a space bridge (FIG. 1). The head node is Earth and the end node is Pluto. The end node serves as an artificial wormhole or a space portal that allows Earth to capture the current light coming from Pluto. As I've said before, it takes 5 hours to send light to Earth from Pluto, but with this space bridge Earth can get the light as it happens—in 0 second. This type of space portal can only see but not touch. This space bridge can read the current light that is coming from Pluto from the end node, but, unfortunately, Earth can't touch physical objects on Pluto, or deliver physical items from Earth to Pluto. All activities on Pluto, via light, will be sent to Earth immediately using 0 second because of the space portal, as if Earth was occupying the same space as Pluto. The space bridge is just a network of connected computers that propagate implied digital information from node to node so two planets can communicate with each other.

This space bridge (aka network pathway) can be as long as we want it to be, it can be 90 billion light years in length. It will permit Earth to see the current state of a planet at the end of the network pathway, instantly. What we are trying to accomplish is to take all the light coming from Pluto and teleport it to Earth in 0 second through an AI portal. Light on Pluto takes 5 hours just to reach Earth, what the space bridge does is it takes the light from Pluto and teleport it directly to Earth in 0 second. Thus, instead of waiting 5 hours, Earth got the light in 0 second. 0 second means the data transmission was instantaneous between Earth and Pluto. Once the space bridge is established between two planets in a two way communication, then both planets can see each other and they can communicate with each other live, in real-time.

This space bridge is infinitely faster than what we have today. It can transport infinite amounts of data in 0 second (using no time) regardless of the distance apart between planets, even for planets that are 90 billion lightyears apart.

The end node of the network pathway creates an artificial portal between Earth and Pluto. Current light from Pluto goes through the artificial portal and sent to Earth where Earth's AI can use that data to map out every atom, electron and em radiation on Pluto. This 3-d atom map of Pluto will give Earth all of Pluto's digital activities (their entire activities over Pluto's internet) as well as all physical activities on Pluto's surface. Both Pluto's digital world and physical world are represented in this 3-d atom map for Pluto's current state, and each atom, electron and em radiation in this 3-d atom map is updated in real time.

If Earth wants to establish a Universe internet with all planets in the Universe, Earth must build a network pathway for each planet in our Universe. Each space bridge constructed helps other space bridges nearby see farther into the Universe. The end result is a massive network of forest and trees of space bridges connecting multiple planets. At the center of the network is Earth.

It's true that this AI space portal can only send digital signals from planet to planet, but if we combine the Universe internet and the ghost machines (aka global telekinesis), Earth can physically touch objects, in real time, that are located on a planet 90 billion lightyears away.

How to build an internet for 2 planets 90 billion lightyears apart.

Using the last method, we increase the equally distributed space stations between the two planets. The farther the distance between two planets, the more space stations are needed. I would estimate that trillions of space stations are needed in order to build an interplanetary internet for 2 planets 90 billion lightyears apart. The idea is to have the two planets synchronize their time; each planet has to have the current state of all atoms on the other planet. Earth can see the current activities on the alien planet, and vice versa. This is about mapping all the atoms, electrons and em radiations of a planet. By mapping out all the atoms and their sub-atomic particles of a planet's current state, the AI can see all the activities on the planet for both its digital world and the physical world. Once a planet's AI can see all the locations of each atom, electron and em radiation on a planet, it can communicate with that planet in real time. All current activities of a planet include all activities over the planet's internet.

Think of each space station as a computer with a harddrive, and Earth is trying to map out and read station1's harddrive, and station1 is trying to map out and read station2's harddrive, and station2 is trying to map out and read station3's harddrive, and so on until Pluto is reached. Each station has to relay their 3-d atom mapping data (which contains the transmission data list and routing information) with neighboring computers, sending data back and forth in the network.

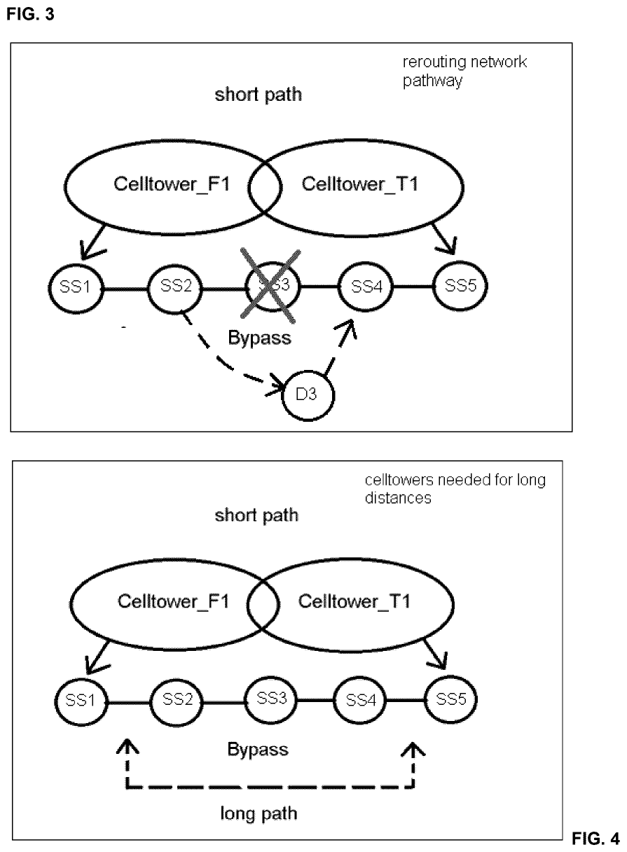

The network pathway or route has to be robust. If one of the space stations isn't working or is destroyed, the network pathway can reroute to nearby space stations just like a regular network system (FIG. 3).

FIG. 4 depicts a diagram showing hierarchically structured celltowers. In addition to space stations, these celltowers are there to transmit data for long distances faster. Each celltower is trying to group transmission data from a cluster of individual space stations.

Also for simplicity purposes, I only discussed communications between two planets, Earth and Pluto. In reality, billions of planets in the Universe will be communicating with each other and the network topology will be massive, spanning many different network structures and trees/forest structures, both connected and not connected, to relay information from senders to receivers for all planets in the Universe.

The scaling problem of the signalless internet is no problem. It works for a city, a country, a planet, a solar system, a galaxy and for the entire Universe. The lightyear distance is no problem too, the Signalless internet works for planets that are 90 billion lightyears apart. It even works for two planets that are 90 zillion lightyears apart. The only problem is that the spaced out network computers that connects the route between the two planets has to be established in order for the two planets to communicate with each other in real time. At first, back in 2008, I thought the network pathway (or route) is unnecessary and that Earth's AI and Pluto's AI can predict the other planet's atoms for the current state without the space stations. I was wrong . . . the network pathway is crucial to building a signalless internet and also to distribute information to all users on a planet.

Let me give you an example. Let's suppose that you have two planets, Earth and Malaxy, which are 26 lightyears apart. A ship was sent from Earth to travel to Malaxy using lightspeed. In the middle of the flight, the propulsion system on the ship breaks and it is stranded in deep space between the two planets. The captain of the ship is screwed because he has no way of communicating with either planet. The planets are so far away that using digital signals it would take 10 years just to reach Earth. By then he would be dead. However, if there was a network pathway between Earth and Malaxy, a neighbor space station might be able to locate the lost ship and even relay implied transmissions to the ship (given the ship has the same 3-d atom mapping technology). The network pathway maps out all the atoms, electrons and em radiations of space at and between Earth and Malaxy. Thus, the space stations network between the two planets can serve as relayers of information to anyone that is nearby to a space station.

Even on Earth, the peer to peer computers are necessary in order to relay information to individual users. If country1 and country2 has all the current atoms tracked on Earth and can see all activities on the planet, that only benefits country1 and country2, but what about individual users? How does country1 deliver messages to individual citizens in their country? The computers have to be scattered equally on Earth (just like celltower coverage and cellphones) so that every square inch of the planet is covered. Each person must have access to the internet no matter where they are located on the planet. The equally distributed computers comprising the signalless internet will be able to deliver messages to all people on planet Earth.

### Other Topics

### The AI's Range of Prediction

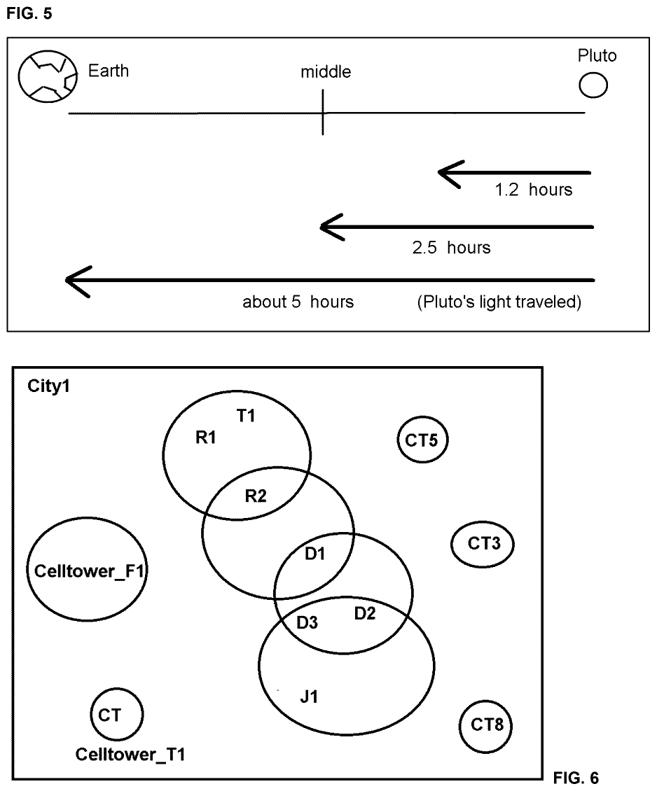

FIG. 5 is a diagram depicting the range the AI can predict light coming from a planet. We have to treat the entire Universe as a network of interconnected nodes of atoms, electrons and em radiations. When these nodes interact with each other, each node is changed, and the entire network as a whole is changed. Pluto's light reaches Earth in 5 hours. There is a 5 hour time limit, Earth's AI has to predict Pluto's light before it reaches Earth. How does the AI do this?

Light moves faster than atoms so we will focus on light interactions. Individual photons affect individual atoms. For instance, photons change an atom's electron's orbiting position and its photon emission type, direction, and emission time. An electron's spin can also be affected by light. Photons also affect other photons. These changes through light interactions are barely visible, but can easily be identified by AI.

Light travels at the speed of light. The area Pluto's light reaches is the area that can be predicted by Earth's AI because Pluto's light changed the atoms, electrons, and em radiations in the space it touches. Because the space it touches is changed, the AI is able to do research and find out what caused the changes. And if it is successful, reconstruct the light coming from Pluto before the 5 hours.

The middle, between Earth and Pluto, is where Pluto's light has traveled so far, which is 2.5 hours into its trip. When Pluto's light touched the middle, the space there is changed. The atoms, electrons and em radiations are changed in subtle ways. If Earth's AI can predict the middle space, it can reconstruct the changes made in the middle space and therefore predict Pluto's light. If Earth's AI is successful, instead of 5 hours to get Pluto's light, it can get the light in 2.5 hours—in half the time.

The space stations are there to see farther out and get a more detailed image of Pluto. We must create more and more space stations connecting Earth to Pluto. And use a signalless telecommunications for these space stations (computers) to relay information back and forth. The end node, which is right next to Pluto, serves as an artificial portal, and through it we can get Pluto's current light to Earth in 0 second.

Let's go back to FIG. 1, the half way point is where Earth's AI can predict or map out the atoms, electrons, and em radiations there. What if we included a space station there, in the middle. The AI of Earth is able to predict all the atoms of the space station including its computer's harddrive. That middle space station also has AI and is trying to map out the quarter distance to Pluto. By reading all the harddrive data in the middle space station (SS4) we can also get all the 3-d atom mapping for that quarter distance to Pluto.

We have to do this recursively where more and more space stations are equally distributed between Earth and Pluto. For instance, in the middle space station, there is another space station between it and Pluto. The closer the space stations are to Pluto, the shorter the distance to predict. The 3-d atom mapping data is propagated from space station to space station and transferring information to and from Earth and Pluto. “each space station is transferring implied data faster than the speed of light.”

Each space station's AI in the network pathway is predicting Pluto's light half way. When we combine their collective predictions together it cuts the distance to 0 between Earth and Pluto, and the network pathway is able to capture Pluto's current light and deliver it to Earth in 0 second instead of 5 hours. The network pathway (space bridge) works in two directions, from Earth to Pluto and from Pluto to Earth.

Conclusion: Despite the method used to build this AI teleportation device, this is real teleportation and it does exactly what it's supposed to do. I have invented over 100 inventions, all centered around human level AI and Super AI. Teleportation is one of the most sought out inventions in the scientific community. I, Mitchell Kwok invented the first teleportation device in history. I'm absolutely certain, without a shadow of a doubt, that this invention will work and is implementable in the real world.

Without this AI teleportation, my Universe internet won't work. AI teleportation is the heart of my Universe internet invention; it is the most important component of my invention—it's like an engine to a car, or a heart to a human. This is what allows two planets 90 billion lightyears apart to communicate with each other in real time. With the discovery of this technology, Einstein's theory, “there is no master clock for the Universe” is completely wrong. The master clock is needed to permit instant interplanetary telecommunications.

Let's take a look at how I invented AI teleportation. Like I said, I invented over 100 inventions in my lifetime and each invention is an evolution of AI. I was able to jump from one invention to another. I combined ideas, I used trial and error, I brainstormed new ideas, and that is how I came up with AI teleportation.

There are many scientists that are smarter than I am and they did research for decades, but how come I was able to invent AI teleportation and not them? I think that all the physicists were looking in the wrong direction and field. They were supposed to do research related to artificial intelligence and computer science instead of physics and chemistry. I was able to solve the problem because I combined both physics and computer science, especially AI, together. Most of my inventions were based on accidents. I was trying to invent a Universe internet (2008) and then I ran into the lightyear problem. And in solving the lightyear problem, I was able to invent a real teleportation machine.

All my inventions are well documented from a legal point of view. I filed 30+ patents on all inventions, at least the most important ones, and published hundreds of books and videos online. Every piece of information regarding everything I published are “registered” copyrighted material (invention descriptions, examples, demonstrations, etc.) and are owned by Mitchell Kwok. All copyrights rights and patent rights reserved.

### Review

To better understand how this Signalless internet works, let me post a review. This example describes a signalless internet for a single city. The concept is the same regardless of the amount of computers in the network and the distance of the computers.

How to build a 100% signalless internet for Earth and then for the entire Universe

We start with a network in a single city that spans 20 miles, then we'll apply that same network technology to ever more larger areas, first a state, a country, the Earth, a solar system, a galaxy, and finally the entire Universe.

Each computer in the network can be either an individual computer (ex. smartphone, desktop computer, tablet, terminal, etc.) or a server. Each computer in the network has an atom mapping radius that is a vital part of the computer. This is the range in which the mapping technology can track all the atoms in its immediate environment. Referring to FIG. 6, computer_R1 has an atom mapping radius of 100 yards, which means its AI was able to track every atom accurately for 100 yards within the radius area.

Computer_R1 can now see computer_R2 and computer_T1. This means computer_R1 has every atom structure (and their sub-atomic particles like visible light) of both computers, including their respective harddrives, monitor information and the physical objects around that computer, such as the user's body actions and mental thoughts. Computer_R2 can see computer_R1, but its atom mapping radius also include computer_D1. Next, computer_D1 can see two other nearby computers: computer_D2 and computer_D3. Finally, both computer_D2 and computer_D3 has an atom mapping radius that can see computer_J1.

The celltower_F1 is just a hub that collects all the 3-d atom mapping information from all the nearby computers and creates a 3-d atom map of the entire City_1. The individual computers don't store the overall atom map, only the celltowers do that.

How does the computers transmit information from computer to computer in the network?

Again, no digital signals are sent in the air via radio waves or microwaves. There are no radio transmitters and receivers in any of the computers or celltowers. If that is the case, then how are the computers suppose to transmit data from node to node in the network? The answer is through the atom mapping radius. Each computer has an atom mapping radius that tracks nearby computers; computer_R1 can see computer_R2. Every single atom of computer_R2 is visible to computer_R1 (and vice versa). The main focus is on computer_R2's harddrive where digital data resides, and within the digital data are the transmission data that computer_R1 wants to transmit to computer R2 (and vice versa).

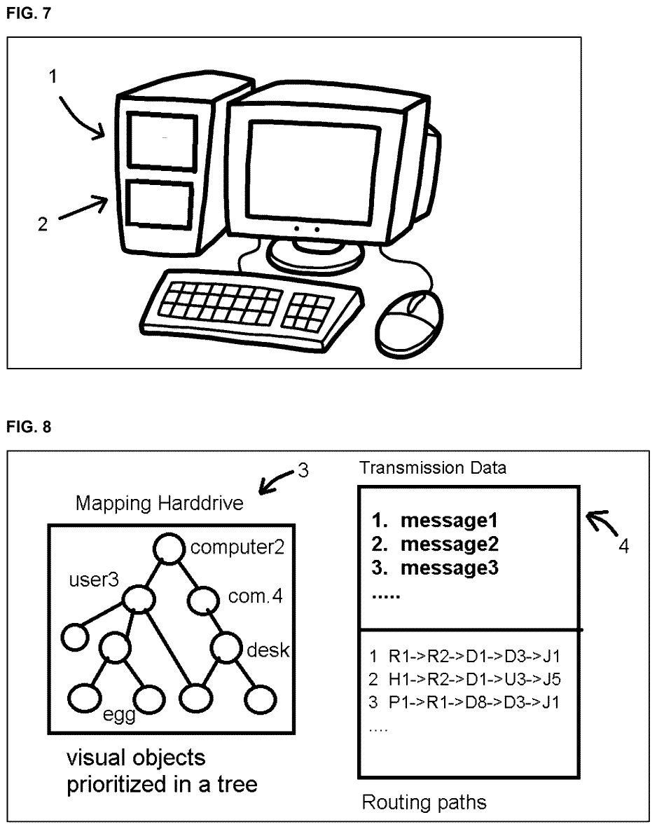

Let's take a look at how these computers are constructed. Referring to FIG. 7, each computer has a mapping harddrive, where there is an atom mapping of the area and close to it is the computers' harddrive to store data. Both should be visible and not encased in the computer (these harddrives need to be exposed). The mapping harddrive (pointer 1), basically, is the atom mapping for that radius and it shows all the atoms for that atom map radius. For instance, computer_R2 has atom tracking information on computer_R1 and computer_D1, and computer_R1 has atom tracking information on computer_T1 and computer_R2. The harddrive of a respective computer (pointer 2) is just data that is stored in the computer. Data can be anything like digital files, software programs, transmission data, server data, etc.

Let's imagine that computer_R1 wanted to communicate with computer_J1 (R1->J1). Just like the current internet, computer_R1 will make jumps in order to get to computer_J1. Here is what the network route path will look like:
R1->R2->D1->D3->J1

Now if computer_D3 is down or not working, computer_D1 can reroute to computer_D2 to repair the network break.

FIG. 6 is a diagram depicting the process of implied transmission data propagation. Computer_R1 is reading computer_R2's mapping harddrive, which contains all the atoms of computer_R2 including its embedded harddrive. Next, computer_ R2 reads computer_D1's mapping harddrive, which contains all the atoms of computer_D1. Next, computer_ D1 reads computer_D3's mapping harddrive, which contains all atoms of computer_D3's mapping harddrive. Finally, computer_D3 reads computer_J1's mapping harddrive, which contains all atoms of computer_J1. The implied transmission of data happens when all the computers in the routing path (between R1->J1) updates its mapping harddrive in real time. The transmission data from computer_R1 uses implied propagation to get to computer_J1. At this point computer_J1 finds out, through its neighboring computers, that computer_R1 wanted to send it a message, and sees the message through its neighbor's mapping harddrive.

These are peer-to-peer type of computers and the AI, from its atom mapping radius, should focus on objects that are important. These objects in the atom mapping radius should be hierarchical and goes from important to least important. The most important objects are neighbor computers and the people who are using these computers. Referring to FIG. 6, for each computer, the visual object data are prioritized further. Each computer has a mapping harddrive and within this mapping harddrive is the computer's own atom map radius. For example, in computer_R2 its mapping harddrive has computer_R1 and computer_D1 in its atom mapping radius, and computer_D1 has computer_D2 and computer_D3 in its atom mapping radius.

Referring to FIG. 8, pointer 3, let's focus our attention on a computers'important “extraction data.” Within the mapping harddrive all the visual objects (comprising atoms) are hierarchically structured with great importance on neighboring computers and users of the signalless internet. For each computer, there is a list of transmission data. The routing data is a list of routing network paths from sender to receiver. For each of these user connections is a transmission data, one way (pointer 4).

Suppose user88 from computer_R1 wanted to do a zoom video chat with computer_J1, the extraction data will be the visual data of user88 on computer_R1, and the user56 on computer_J1. Each computer's AI has to generate a live video on the sender and send it to the receiver. Users don't even need cameras for this zoom live chat. For example, the AI on computer_R1 will take the visual data on user88 on computer_R1, generate a live video and put it in the transmission data to be sent to computer J1. Then, on the opposite end, the AI in computer_J1 will see that there is a transmission data from computer_R1. Computer_J1 will then read that data, which is the live video of user88 on computer_R1. In order to get a two way communication, a zoom live chat, user56 on computer_J1 has to do the same thing, and its AI has to create a live video on user56 and put that in the transmission data to computer_R1. Updates are live, and in order to do that, transmission data are send back and forth in real time between computer_R1 and computer_J1. This is how you do a live zoom chat in a signalless internet.

This is what the transmission data will look like:
Routing data: R1->R2->D1->D3->J1
Transmission data: live video of R1 to J1
The AI creates a live video of the user at computer_R1 and wants to send it to computer_J1. Once computer_J1 gets the live video its respective AI will do the same and create a live video of the user at computer_J1 and send that transmission data to computer_R1, which will look like this:
Routing data: J1->D3->D1->R2->R1
Transmission data: live video of J1 to R1

This repeats itself every second to get a live video chat between computer_R1 and computer_J1.

If during the live chat computer_R1 wanted to send a large 30 terabyte file to computer_J1, the steps include: computer_R1 sends a link of a sector of the harddrive to send (this will show exactly where the file is located in computer_R1's harddrive). Next, the AI in computer_J1 will get the transmission and cut and paste the 30 terabyte file to computer_J1's harddrive. The download was done in 0 second, with no transmittal of digital signals in the air. All the AI did was cut, copy and paste a file from its atom mapping technology.

The browser used by computer_R1 and computer_J1 to surf the signalless internet are “dummy software.” They don't really connect to the internet at all. The AI is actually delivering things between the sender and the receiver through input from these dummy software. The users can use any type of communication method to send messages, it doesn't have to be through computers via text or live videos. They can use hand gestures, they can use any language they want even made up ones, they can use Morse codes, they can write the messages on a piece of paper; they can use any means possible to communicate with each other. The AI of each computer is simply analyzing the sender, and delivering the message/s to the receiver.

If the sender types out a message in the text box of a software program, the moment the sender pushes the send button the AI has to deliver that text to the receiver. In another example, if user45 wanted to use a physical notebook to communicate with user56 on the opposite side of the Earth, the communication medium is hand writing. If user56 says “no way, I want to use hand gestures instead”, the AI has to cater to users in terms of what communication method each user prefers. Later I will go into other examples like how to download websites and setting up a social media network, or something more complex like setting up an e-commerce network. For now let's go back to our main topic.

The network routing path:
Routing data: R1->R2->D1->D3->J1

For every computer in the routing path, each has to update the latest information from their respective data transmission list. Each computer must monitor all neighbor computers and to update all transmission data from its data transmission list. This is how transmission data is relayed from computer to computer to get it from the sender to the receiver. New transmission data are inserted, modified or deleted in the network routing path by any number of users, and is very dynamic. Each computer in the network routing path must constantly monitor other computers'updated mapping harddrive to get the latest transmission data, and in which direction to send this transmission data.

### Celltowers

Referring to FIG. 6, if the sender and receiver are very far apart, hierarchically structured celltowers can be used to relay transmission data for far distances. Let's say that computer_R1 wanted to send a transmission data to computer_J1, which is located 60 miles away. Suppose celltower_F1 has an atom mapping radius that covers 3 cities, and that celltower_F1 is close to computer_R1, and conversely, celltower_T1 has an atom mapping radius that covers 3 cities and can see celltower_F1 and is located near computer_J1, then celltower_F1 can send computer_R1 the transmission data and celltower_T1 can send computer_J1 the same transmission data. This bypasses the longer network routing path.

Remember, celltower_F1 merges all the atom mapping radius of R1, R2, and D1, while celltower_T1 merges all the atom mapping radius of D2, D3 and J1. Now celltower_F1 and celltower_T1 can see each other and all of their respective transmission data.

Referring to FIG. 6, These celltowers are hierarchically structured and they share information in levels. The entire city is represented by celltower_F1 where all the atoms of City1 are tracked and stored in one linear timeline. Notice the lower levels of celltower_F1. It has 3 lower level nodes. These 3 lower level nodes have bits and pieces of celltower_F1. Thus the upper level nodes merge all the information from the lower level nodes (reducing repeated information). The lower level nodes (represented by individual computers) help construct a bigger map for the upper level nodes (represented by celltowers).

AI teleportation, AI portal, or artificial wormhole—these are different names referencing the same technology: instant transport of infinite digital data and physical objects across long distances. We are talking about lightyear distances between planets. The space bridge (aka network pathway) we talked about earlier provides instant transport of digital data, but what about physical objects? The function of a teleportation machine is to get a physical object from one location to the next instantly using 0 second.

### How to Teleport Physical Objects Between Earth and Pluto

Referring to FIG. 1, this diagram depicts the space bridge between Earth and Pluto. Using our earlier method we can transport digital data from Earth to Pluto in real time, but we can't transport physical objects, nor can we manipulate objects on Pluto's surface.

This is a very easy problem to solve. In addition to the space bridge, each planet must have their own global telekinesis. A user on Earth has to use a 5 sense VR technology to experience a hyper-realistic simulation of life on Pluto based on the user's point of view and using their 5 senses: sight, sound, taste, touch and smell. The AI on Earth takes all the current data on Pluto, like its environment and its activities on the surface, to create a VR simulation for the user on Earth. Simultaneously the AI on Pluto has to use global telekinesis to generate a physical ghost construct of the Earth user on Pluto. This ghost construct will look exactly like the physical body of the user on Earth. The ghost construct will be able to touch objects on Pluto, shake hands with people, or participate in a live sports event.

What is essentially happening here is that the user on Earth is given a realistic vacation experience on Pluto and is sensing things as if he was on Pluto. This is a vacation so real that the user can't tell the difference between the VR simulation and the real thing. While the user is experiencing the VR simulation, the AI on Pluto is using global telekinesis (using an atom manipulator) to generate a ghost construct of the Earth_user on Pluto. This ghost construct can look and feel like the real thing. When the ghost construct shakes hands with the tour guide, the handshake will feel real as if the Earth_user was on Pluto in person shaking hands with the natives there. The visual ghost construct will look real and people on Pluto will see the Earth_user—not as a ghost, but as a real person.

The Earth_user eating food on Pluto might be a bit of a problem, but can easily be remedied. The ghost construct on Pluto buys food at a restaurant and takes a bite at a delicious cheeseburger. The ghost construct is real and is biting on the food, smashing it into tiny pieces and then swallowing it into its internal stomach. All the sensations, from the taste buds to the pressure of the bites are all sent to the user on Earth as a simulation. Even the food particles traveling down the Earth_user's throat and into his stomach are perfectly simulated. Next, for the ghost construct in Pluto, the AI is using the atom manipulator to disintegrate the food particles in its stomach content atom-by-atom into bio-fuel, like water, dirt or air. It's as if the food the ghost construct has eaten is broken up into elemental molecules and discarded into the environment.

Obviously, this type of teleportation isn't really teleporting physical objects or digital signals across vast space. It's an illusion that gives the impression that physical objects can teleport from planet to planet. The important thing is that this 5 sense VR technology works exactly like real teleportation. If the Earth_user is asked if he can find any discernible difference between a real vacation on Pluto and a VR simulation of the same vacation on Pluto, he won't know the difference. The vacation of the two are indistinguishable in the mind of the user.

The VR simulation on Earth and the ghost construct actions on Pluto are occurring at the same time and live. The VR simulation is happening on Earth in real time and the ghost construct is existing on Pluto in real time.

There are also evidence that the Earth_user physically visited Pluto and have been there. He shook hands with the tour guide, people saw him on the beach, surfing the big waves, and he ate food at a local restaurant on Pluto. Even the cheeseburger that was made by the restaurant disappeared. Not only was the Earth_user able to experience a hyper-realistic vacation on Pluto but he was able to interact physically with the objects on Pluto's surface and changed these objects.

This 5 sense VR technology is even better than Star Trek's warp drive technology. We can teleport a ship with a crew of one hundred to a planet 90 billion light years from Earth in 0 second, and this ship can touch objects and sense the environment as if a real ship was there. This is AI teleportation for the entire Universe spanning a diameter of 93 billion lightyears for the seeable Universe and 10× more for the unseeable Universe. A user can open a portal and go anywhere in the Universe in 0 second, regardless of the distance from Earth, and sense and touch objects that are currently happening there.

Let's suppose a user on Pluto buys a statue from Earth, how is the statue going to arrive on Pluto? The buyer from Pluto makes the order on Earth's website and Pluto's global telekinesis will re-create the statue in the buyer's home atom-by-atom. The atom manipulator located in the buyer's home is taking the statue's atom file from Earth and recreating a perfectly identical statue on Pluto atom-by-atom using AI alchemy. The end result is the statue the Pluto buyer bought from Earth's website. The statue on Pluto will look exactly like the statue on Earth—both are identical at the atom level.

Again, this isn't real teleportation of the statue, but the technology works the same way. At the end, the Pluto buyer receives an identical copy of the statue that is located on Earth.

A real teleportation machine that actually teleports physical objects from pointA to pointB.

In this section we'll talk about “real teleportation” of physical objects. We know that the space bridge can teleport digital data, now we explore possibilities of teleporting real physical objects from pointA to pointB.

Let's imagine that Jake on Earth wants to teleport to Pluto. The first stage is to break up Jake atom-by-atom into chunks of atoms and molecules, each atom and its subatomic particles are serialized using blockchain hash codes. Next these chunks of atoms are sent to Pluto as streaming “atom packets.” These packets have to slowly travel in space to get to Pluto. The space bridge between Earth and Pluto is used to monitor and deliver these atoms to Pluto and to ensure none of the atoms are lost in space.

Even if these atom packets were traveling at the speed of light, it would take 5 hours to get to Pluto. Once these streaming atom packets get to Pluto, they are collected in a temporary storage area. Just like digital packets, they have protocols that will check if all the atoms arrived at Pluto correctly. Finally, an atom manipulator located in Pluto will take the chunks of atoms and reassemble them to form Jake.

This type of teleportation isn't instantaneous and requires time to complete. A solution to this problem might be found in the description on AI relativity (described later). I stated that when a ship moves faster than the speed of light, the ship is traveling past lightspeed, but outside, all objects in the universe including gravity and photons are frozen and set to 0. At 0 the ship is still moving forward, but the Universe is in a frozen transitory state. This implies that the ship can travel faster than light in a frozen environment. The more force applied to the ship, the faster it travels beyond lightspeed, and the time used for travel is 0!!! And time itself never ticks as long as the ship is traveling above the speed of light. This essentially means this ship can get from pointA to pointB regardless of the lightyear distance apart in 0 second. However, The ship's occupant will experience a much longer trip than 0 second.

This is just a theory of mine and if it is proven, it can teleport a physical object/s instantaneously from pointA to pointB for the entire Universe. In the case of Jake, he can get into this 0-time ship and teleport to Pluto in 0 second. Heck, Jake from Earth can teleport to an alien planet 90 billion lightyears away in 0 second!!!!

### Future Space Exploration

With this said, the space exploration we envisioned in Star Trek is derailed. No ship will be sent out to space to do any type of space exploration. The only exploring we will do are those done in a digital world using the Universe internet.

The Universe atom timeline is the tracking of all atoms, electrons and em radiations in the Universe and stored in a timeline with real time updates. With this atom mapping technology of the Universe, we can see every object or activity in it. Therefore, there is no need to physically fly into space to discover information about our Universe we already know. People can view anywhere in the Universe currently or in the past in a VR computer simulation, and the VR experience will be so real it's like being there. Thus, there is no need for astronauts to travel on a ship to discover knowledge and to risk their lives unnecessarily.

Unfortunately, Earth needs to send out equally distributed space stations centered around planet Earth. I assume these are either built by robots or it is self-replicating that uses material from its current environment to make. The hard part is connecting all the planets to Earth. Space bridges, which are networks of space stations, must be built for each planet Earth wants to connect to.

Some people would ask, “what's the difference between your idea and the ideas in the media?” True, both of our ideas of self-replicating satellites or space stations are the same, but my idea includes a signalless telecommunications system. Each space station in the network pathway has to propagate implied data transmissions from station to station in the network.

To illustrate this point, let's take a look at a conventional space station network. Each space station in the network is transporting digital data using 5G telecommunications (sending digital signals at lightspeed). If we applied this to Pluto and Earth it would take 5 hours to get a signal between planets. It would probably take more than 5 hours because each station has to stop the signal and redirect the signal to nearby stations, or there might be signal disruptions like solar flares, gravitational distortions, or space object obstructions such as asteroids, space debris, or signal blockage by planets or clouds of gases.

It's building these space bridges between planets that is difficult. But once that space bridge (network of space stations) is built between two planets, all the atoms and square micro-inch of space between the two planets are visible to the AI. The premise is to build networks of space bridges connecting all planets in the Universe so that the AI can see everything in it. In addition, these networks of space bridges gives the AI the means of delivering messages in real time to all users of the Universe internet, regardless of where each user is located in the universe.

### How Earth can Sell Services to Distant Planets Using This Space Bridge (or AI Teleportation)

I want you to imagine a scenario where a robot on Earth wants to sell a service to 50,000 people on both Earth and Pluto using a website posted on the universe internet. The service is heart surgery. This robot has to do heart surgery on 25,000 patients located on Earth and 25,000 patients located on Pluto. In order to make profit, all surgeries have to be done simultaneously, and it takes 3 hours to perform per surgery. How can one robot perform 50,000 surgeries for two planets in 3 hours time?

A human surgeon can't do this, only a super intelligent robot that has the ability to make copies of itself in the virtual world can do this. This task of performing 50,000 heart surgeries can't be done by an individual robot. In actuality it has to be done by a team of robot doctors and robot nurses using medical equipment. Let's call the team “the robot hospital”, where there are primarily 5 robots, each specialized in their fields to perform the surgery. But, at the same time, they have back up of an entire hospital staff in case things go wrong. The 5 robots in a team include: 1 heart surgeon, 1 anesthetist, 2 nurses and 1 AI helper.

The robot hospital (the team of 5 robots) goes into the virtual world and makes digital copies of itself. That's one robot hospital per patient. Since there are 50,000 patients, they have to make 50,000 copies of their team. Each heart surgery is performed on different people and locations, 25,000 residing on Earth and the other 25,000 residing on Pluto.

Each planet has global telekinesis and can generate ghost robots and ghost machines on site (anywhere on the planet) to perform surgery. Each robot hospital will use a planet's global telekinesis to perform all the heart surgeries.

Let me explain what each heart surgery will look like and how it works. In each instance, a robot hospital is generated for each patient at their home. Global telekinesis generates 5 ghost doctors and ghost medical equipment in the patient's home. Everything is done using smart forcefields generated by a local the atom manipulator. When the robot doctor cuts open a patient, the atom manipulator is using lasers to break apart the skin and using forcefields to prevent the blood from coming out. Or, as an alternative, the atom manipulator can create a ghost knife to cut open the patient and ghost hands to pull the skin apart.

Each robot do different things. For example, the nurse is there to assist the robot doctor with ghost tools and to make sure the patient is asleep. The robot anesthetist have to monitor the patient by looking at a ghost monitor device to check variables like heart rate, breathing rhythm and brain activities. He then has to communicate with the ghost doctor to feed him information in real time about the patient's current condition.

These are expert robot doctors that work in a team, and they perform better than humans and the success rate is almost 100%. They do extensive research before each surgery and make sure the outcome of the surgery is successful. But, after the surgery, if the patient rejects the heart or there are minor complications like tissue incompatibility, the surgery will be a failure. That's not a big issue because these robots were breed to perform at optimal levels. They got the best knowledge and the most experiences. Every surgery they do (in the billions) is fed right back into their real brains and they get better and better after every surgery. An evolution of new methods and procedures are utilized after every surgery.

All 50,000 heart surgeries are done for both planets, and they were done simultaneously, or at the convenience of the patient. Each surgery is done by the same group of robots, focused on the robot heart surgeon. The robot hospital created 50,000 instances of itself and performed 50,000 separate heart surgeries; spanning two planets. They were all done in 3 hours.

Selling services to distant planets from Earth applies to all services in all industries. A robot on Earth can build a house on Pluto. A robot from Earth can do a painting on a building on Mars, or a robot can just sit down and chat with a person on an alien planet lightyears away.

If you look at the robot hospital, it has various medical departments, such as: robot dentist company, robot eye company, robot plastic surgery company, robot pain company, robot hospice care company, robot dermatologist company, robot fertility company, robot brain surgery company, robot cancer center, etc. Each department does different things, and these robot companies can perform their jobs at a professional level—either equal to or better than human companies.

Humans can perform services too, but it's not real-time services and one at a time. The human has to make an identical copy of itself for both brain and body as a digital character inside the virtual world. So, digital copies of the human are used to do the services in distant planets. It can make as much copies as it wants for every instance of service. The disadvantage is that the human can't learn from all these digital experiences and gain more knowledge and skills. On the other hand, robots can take all their experiences and learn from them and apply them to becoming better workers.

For a planet's global telekinesis, it generates ghost robots and ghost constructs anywhere on the planet to perform a job, and also to perform AI alchemy by either transforming an object at an atom level, or to newly-create an object from thin air. For instance, ghost construction workers are needed on the building site, and building materials are created from thin air. A door is created from atoms in the air, and when that is done, a ghost construction worker takes the door and installs it in a room.

However, there is a faster way of building a house and that is through AI alchemy. Using atoms in the environment or atoms from a reserved storage area, the atom manipulator builds the house atom-by-atom by printing the house out. No ghost construction workers are required, nor their intelligence needed to build the house. The AI is controlling a local atom manipulator and printing out the house atom-by-atom according to an atom file of the house.

### 2 Types of Implied Transmission Data for the Signalless Internet (aka Universe Internet)

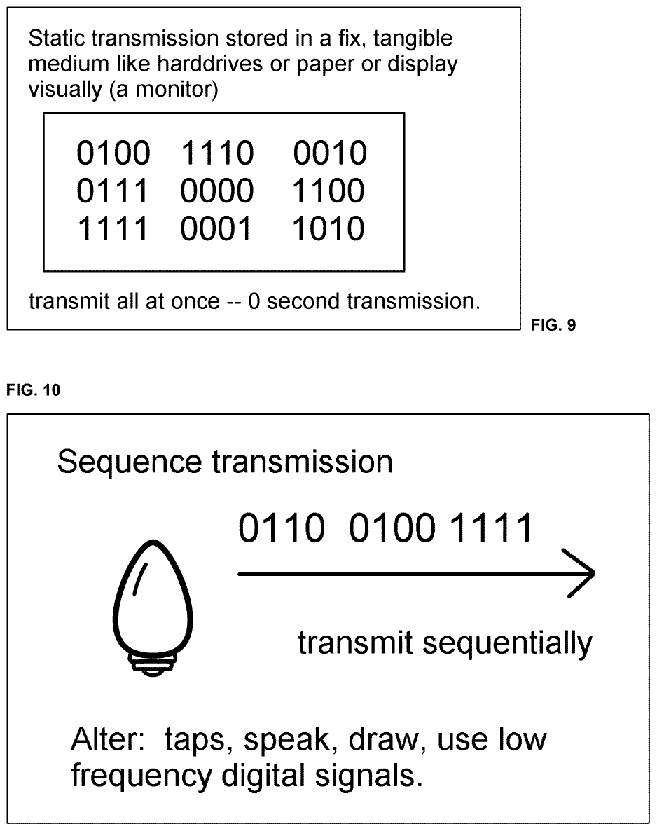

There exist two types of transmission data: (1) static transmission data (FIG. 9). (2) sequence transmission data (FIG. 10). The transmission data consist of binary digits, visual actions (like Morse code tapping), sound events, visual events, a snapshot of visual objects, etc. The implied data transmission can be anything that is “visually” extracted from the atom mapping radius of a nearby computer. The AI is looking at linear events for visual objects comprising atoms, electrons and em radiations in this atom map.

In this case, let's use transmission of binary digits. Referring to FIG. 10, the sequence transmission requires time in order to extract the binary digits and the sequential 0's and 1's come from a communication device. The static transmission stores the bits in a storage medium, and it takes 0 second to extract the binary digits—by predicting, visually, all the atoms of a computer's harddrive. As an example, let's suppose we wanted two computers, computer_R1 and computer_D2 to transmit implied signals using the sequence transmission method, and the communication device used is a tiny christmas light bulb situated close to each computer.

Referring to FIG. 11, the two computers are very far apart, about 5 miles distance, and the christmas lights are not visible through line of sight. Instead, the christmas lights are enclosed inside a house in a room; the tiny christmas light bulb can't be viewed by either computers through “line of sight.” The christmas light serves as the communication device to send a discrete digital message to neighbor computers.

A christmas light flashes on and off is a good method for the implied transmission because it's small and it affects all objects in the room of that house, only. The christmas light can transmit a 1 with the light turned on and a 0 with the light turned off. After a sequence of turning the christmas lights on and off, the linear binary bits are transmitted to its surroundings (the room only). Let's suppose computer_R1 transmits a message of 200 bits, which is a message consisting of 7 words to computer_D2. Computer_D2 has to use its atom mapping radius to read the transmission message. The atom mapping radius is the atom map of a computer's 360 degree surroundings. A computer uses a 360 camera along with AI to map out all the atoms in its surroundings. The atom mapping radius is the radius that has all the surroundings mapped out atom-by-atom and the AI is able to see all visual objects and activities, up to an atom level, within the atom mapping radius.

The atom map radius includes the tracking of all atoms and “all em radiations” in its surroundings, so any computer sending wifi signals can be picked up too by the AI. Yes, this signalless internet is compatible with current wifi telecommunications. However, we still want a 100% signalless internet.

Implied transmission data is the ability to view visually the atom mapping radius for “signalless transmissions” sent by neighboring computers. It does this not using wifi but through its AI to analyze events and activities 5 miles away, focused on computer_R1. Computer_R1 can use flashing lights as a method to affect the surrounding environment and make it easier for computer_D2 to predict far away objects and activities. A christmas light bulb can be used as the communication device to transmit digital signals. All computer_D2 has to do is predict the house and room computer_R1 is located in and to analyze the color hues of the walls or objects the christmas light affected. This will tell computer_D2 what binary digits computer_R1 is trying to send.

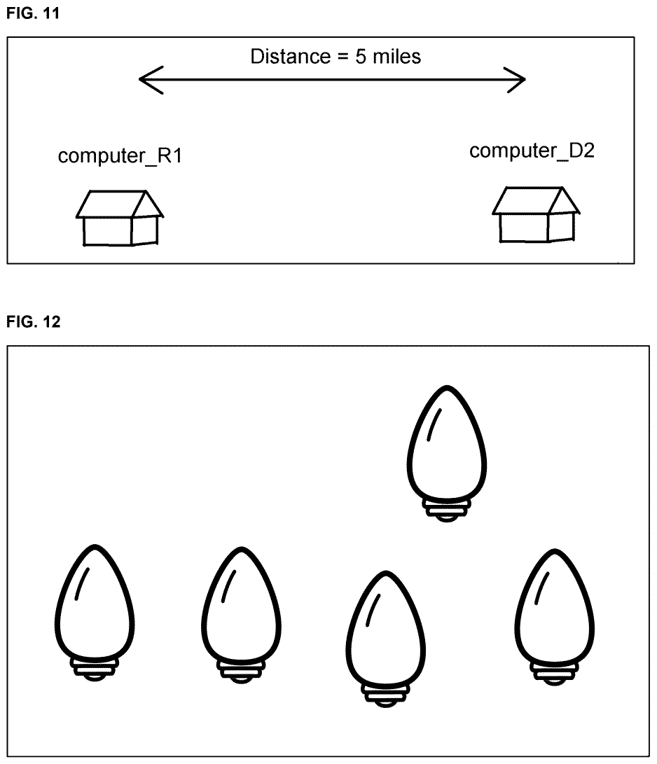

It takes a very long time to transmit binary digits through 1 christmas light. The faster the christmas light flashes on and off, the more binary digits are transmitted and the faster the transmission. The idea is to transmit the digital signals as quickly as possible. Referring to FIG. 12, one way to improve on this model is to have a plurality of christmas lights lined up in an organized way, and they are all flashing unique binary digits in parallel. The more christmas lights there are in the collection, the more information it can transmit, but the harder it is for the AI to read. So it might be wise to space out the lights so it's easier to read. The faster the light flashes, the more data can be transmitted.

A good idea is to use a monitor as the communication device and each pixel on the monitor is transmitting sequential digital signals. Billions of pixels on the monitor are flashing on and off and can be reconstructed as a whole into one digital stream for close by computers to pick up.

Using this sequence transmission method is vastly different compared to conventional telecommunications because it isn't transmitting a digital signal for long distances, but is transmitting a digital signal in a small room. Long range sensors can't pick up on the christmas light flashes. The atom mapping radius's job is to map out the atoms of distant areas and to seek out that faint digital christmas light transmission.

Another method used for implied data transmission is sound events. People can speak and that sound bounces off walls, curtains, glass, paper, etc. and can be analyzed visually by AI to get the transmission data. Thus, instead of transmittal of binary digits, the AI can read transmittal of sound sentences instead. Remember, the AI is analyzing visual data in the atom mapping radius and sound can be extracted from analyzing the vibrations from the walls or the windows (or air movement and direction in a room). That shaking back and forth on the window contains the spoken words or sound. These cause and affect incidents from far away helps the AI to predict the activities inside the room, and therefore extract the implied transmission data the human sender wants to send.

Yet, another method is to use sign language. If the AI can predict what a user's hand gestures are doing currently, it can read sign language. The AI has to use infrared and see heat signatures to see inside a house and in a room where the person is dong the sign language. Once the user's hands are predicted, the AI can read the message the user is trying to send. The AI is identifying visual events in the atom mapping radius, like 3-d objects and structures, air saturation and wind movement. AI is needed to take partial visual data collected through sensing devices to guess the whole data.

Maybe a plurality of receiver computers can work together, to combine their data to come up with a 3-d atom map of the sender computer. One receiver computer has the data from the back of the house and another receiver computer has the data from the front of the house; and they both combine their analytical data to map out all the objects and activities in the house. And while doing this task, the AI can identify the hand gestures or the christmas light sequential transmissions.

### Implied Static transmission

The static transmission data method is preferred for this signalless internet because you want the binary digits to be transmitted all at once using 0 second (there are no linear digit transmissions). If the 0's and 1's of a message are layed out on a fixed tangible medium (FIG. 9), the AI from the receiver computer can read the whole thing all at once, instead of reading the binary digits one-by-one in sequential order. If you have a large file like a 400 trillion terabyte file that you want to send to a receiver computer, it's going to take months just to send that kind of data using the sequence transmission method. But if the 0s and 1s are layed out in a fixed, tangible medium like in a harddrive, the transmission time is 0 second. Once the AI generates the atom map of the sender's computer's harddrive, atom-by-atom, the data is automatically extracted. The up and down groves representing the 0's and 1's of the sender's harddrive is visible to the AI of the receiver computer.

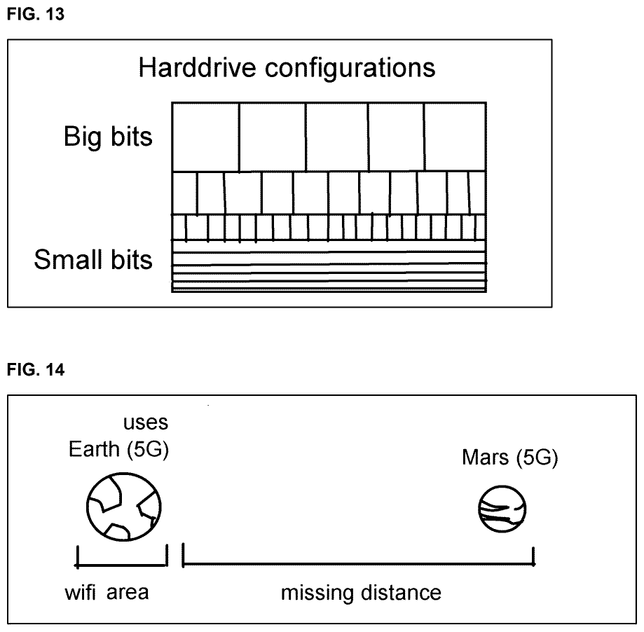

The data transmission in the harddrive are hierarchically structured and the most important data transmissions are outlined first. Referring to FIG. 13, the mapping harddrive can be big for the top level and small for the bottom level. The priority transmissions are located at the top level and the minor transmissions are located at the bottom level. If you zoom in on the harddrive, the bits at the top are big and the bits at the bottom are tiny and small—the bits get smaller and smaller in the lower levels. This ensures the receiver computer gets the important transmission data first.

Not all implied transmission data are large files. Some nearby computers are sending 20 mb of data. The 20 mb of data are stored at the top level of the harddrive so it's easier for nearby computers to predict. Large data transmissions have to take longer because nearby computers have to predict the lower level data from the harddrive.

Using static transmission data method, large files like 400 trillion terabytes can be transferred in one pass. As long as the file can be stored in a computer's harddrive, the data can be transmitted. If a sender wants to send more data, all they have to do is string computers together and store them close to each other for the receiver computer's AI to read.

This is why reading (or viewing) a sender's harddrive is the key to a truly signalless internet. It is the fastest time possible to transmit implied information from one computer to the next without transmitting digital signals in the air or using wifi.

There are other stupid alternative methods to display binary digits on a fixed tangible medium. A computer can print the 0's and 1's on a piece of paper. The bigger the paper and the larger the digit printouts, the easier it is to identify by the AI. Ink on paper sends natural light, which bounces off walls and travel straight. The AI can predict what is inked on a piece of paper 5 miles away. Instead of printing the digits on paper, the digits can be object displays, like a row of cars with headlights on representing 1 and headlights off representing 0. This large display can be an implied communication for long distances such as communications between Earth and Mars.

### Other Methods for Sequence Transmission Data

Instead of flashing lights to transmit the binary digits, we can use alternative devices or methods. Instead of transmitting a digital code to send English sentences, a user can just speak the sentence out loud. Referring to FIG. 11, the two homes are 5 miles apart and the spoken words in a room in a house can't be heard 5 miles away. But the AI is a spying technology and it is mapping its surroundings in a 3-d atom map. Once it predicts the vibrations inside the room of the home of the sender, the AI of the receiver will be able to discover the spoken words by the sender 5 miles away.

The sender can write text on a notebook or write big text on a chalkboard. The AI of the receiver computer will have to map out atom-by-atom of everything inside the sender's house and be able to identify the message that the sender wants to send. This is a very slow way of transmitting data and isn't recommended.

If the sender wants to send a picture or a video of something in the room, the sender can point a finger at a picture and speak out loud, “send this picture to receiver.” If the sender wants to share a video he is watching, like a movie in black and white, the sender can point to his computer and say, “send this movie file to receiver” or “show this event to the receiver.” The event might be a dog eating the sender's homework papers. The AI of the receiver has to identify the user, his activities, his surroundings, and possible implied transmissions.

Another method to sequence transmission is to use the traditional wifi but with lower frequency. So low that only the room of the sender can pick it up. The computer of the receiver will not be able to pick it up 5 miles away. The AI for the receiver has to map out the atoms and photons of its surrounding radius until it maps out the atoms and photons of the sender's home and, specifically, the sender's room. Predicting some of the wifi's sequential digital signals will identify the low frequency digital transmission.

We can make improvements to our current 5G telecommunications. This Signalless internet might be used in conjunction with low frequency wifi transmissions. This will significantly lower the amount of digital signals transmitted in the air. It will be able to lower the digital signal transmission globally by 95 percent!! Of course, this method will eventually be replaced with a purely 100% signalless internet, where there are no digital signals transmitted in the air.

This method is to use very low frequency wifi signals that is localized to a small room, and with no routers or celltowers nearby, and the AI of the receiver side has to predict the atoms of its surroundings to make up for the missing long distance of the transmission. The AI is predicting the distance that the transmission doesn't reach (FIG. 11). The wifi distance is the distance that the wifi is broadcasting from, localized to a home (computer_R1). The missing distance is the area that computer_D2 can't pick up the low wifi signal. The AI has to map out atom-by-atom for the missing distance. The atom map will include all atoms, electrons and photon locations of the surrounding space between R1 and D2. The most important is the photons inside the room of the sender that the wifi is broadcasting from. If the AI can predict a portion of the wifi area, just a portion of it, it will allow the AI to read the content of the low frequency wifi digital signal.

We can apply this model to planets. Let's say we had two planets, Earth and Mars, and you wanted the signalless internet to use low frequency digital signal between Earth and Mars. The Earth will retain the current 5G telecommunications but localized to Earth. It doesn't broadcast digital transmissions to Mars and vice versa. Referring to FIG. 14, the wifi distance is localized to Earth only and there are no intentional digital transmissions sent outside the Earth and especially to Mars. The missing distance is the space between Earth and Mars. Mar's atom mapping radius has to cover the missing distance and to use their AI to predict Earth's wifi area. There are many digital signals sent to and from on Earth, and Mar's AI has to predict all the digital transmissions—it has to predict the precise location of all the atoms, electrons, and “em radiations” on Earth frame-by-frame every nanosecond and tracked them in real time.

### Low Frequency Vibrations Using Micro Sonar to Transmit Sequential Bits

Vibrations in the windows, the curtains, on carbet, on clothing, etc. can create a larger area where the AI can predict. Predicting the groves up and down and the individual bits of a harddrive is very difficult, but predicting the vibrations of all objects in a home affected by a sequential bit vibration is easy.

For very long distances, and the AI has very little data on the 3-d atom map of a house, it can still read the vibrations affecting the house. This will allow the AI to identify digital vibration transmissions with limited amount of 3-d atom map data to work with. It's easy because the AI can read any part of the home that is affected by the linear digital sound and use that to predict the digital transmission. The AI can predict the vibrations on the walls of the house, the vibrations on the windows (all windows in the house), the vibrations on the carbet, or a combination of areas of the home to identify the digital sound transmission.

This is done by AI using infrared cameras to predict heat signatures, air movement, air saturation, humidity, air temperatures, wind direction and speed, air composition, etc. It's about AI mapping out all the air atoms in the house, and through that, is able to identify digital sound transmissions coming from the home. There are many creative ways and digital tools AI can use to spy on houses far away.

There can be multiple digital sound transmissions in the home, occurring in different rooms. This is how a user can transmit digital sound data in parallel. A user can speed up data transmissions this way. Just like different wifi devices in a home, the AI can isolate each digital sound and identify all sound data transmissions in the home.

The volume of the digital sound can be barely audible by human ears in the home, and yet an AI from 5 miles away is able to reconstruct the linear digital sound based on line of site camera. If the camera is a telescope or binoculars, the AI can predict the linear digital sound from 2,000 miles away. This method (linear digital sound transmission) seems unorthodox, but it is an alternative method to using wifi signals.

For planets very far away, using a loud sound machine to send digital signals isn't a very bad idea, with the sequential bits transmitted slowly and the speaker has to be loud and affects the environment in dramatic ways (lots of shaking in 360 degree radius from the speaker). Using radio waves in 360 degree, which is silent, isn't a very good idea because radio waves don't affect matter much. Sound affects physical objects and that change is profound and will make it easier for Earth's AI to predict what is happening on the alien planet.

How to copy 50 trillion terabytes of data to all computers on Earth using 0 second.

Transferring data from one computer to another has to be done in 0 second. How do we do this? Again, I look to my repository of inventions to solve this inexplicable problem. The simple solution is to use global telekinesis. I define global telekinesis as an AI god that can tracks and manipulates every atom, electron and em radiation on Earth. For a simple example let's say that we wanted to copy all the data in computer_R1 to computer _D3, and computer_R1 has 10 terabytes of information. Just last month I had to copy my entire comic book collection (11 GB) from my computer to my external harddrive, and do you know how long it took that darn thing to complete the task? It took 2 hours, from beginning to ending. I had a fast computer, and I bought the latest external harddrive. With one large file it's easy and fast, but when you have millions of individual files and images, it takes a long time to complete the copying. I need a copying method that is fast and done with one pass; using 0 second.

Global telekinesis is controlled by a single AI god, and this AI god can track and manipulate every atom on planet Earth, including physically manipulating all computers located on Earth. This AI god can control every atom on each computer. The steps involve: AI god reads computer_R1's harddrive and know what to copy. Then it controls a nearby atom manipulator located next to computer_D3 and generates ghost machines (or helpers) to manipulate computer_D3 physically. The AI god zeros in on computer_D3's harddrive. It will then analyze all aspects of computer_D3 if its storage medium is compatible with computer_R1's harddrive. Next the AI will manipulate computer_D3's harddrive and specifically manipulate the individual storage units. Every bit of the 10 terabyte of data from computer_R1 is copied into computer_D3's harddrive bit by bit and using one pass

The analytical and research stage is extremely important because the AI has to make sure that the copying of data is completed successfully in terms of compatibility. This is why AI god has to analyze computer_D3 and understand what type of storage medium it is using, what operating system and version, what chip it is using, etc. This additional information is used to properly transfer the copied data from computer_R1 into computer_D3's harddrive so it doesn't run into problems after the copying is completed.

Now, let's suppose that AI god was tasked with copying computer_R1's harddrive to all computers on the planet, and it has to be done simultaneously using 0 second. As stated before the AI god has total control over every atom, electron and em radiation on Earth. All it has to do is physically manipulate every computer on the planet, and in this case, computers include: smartphones, desktop computers, Tvs, electronic devices, peripheral devices, celltowers, networks, servers, workstations, routers, satellites, etc.—any electronic device that is connected or not connected to the internet. The area for each computer AI god has to manipulate is each computer's harddrive. It has to manipulate the groves up and down of harddrives that represent digital bits. The copying of 10 terabyte of data from computer_R1 to all computers in the world are done simultaneously, using one pass, and using global telekinesis.

In reality, AI god can control every computer and server over the internet. It doesn't just copy files from one computer to another but it does many other things, like deliver messages and perform all internet tasks for all users on Earth. The AI god does this quickly by physically controlling all computers over the internet using global telekinesis. Global telekinesis includes controlling a physical computer's hardware as well as their software.

In a more complex example, AI god is responsible for planetary internet. When Earth establishes an internet with an alien planet in Vega, there are two AI gods: one for Earth and one for the alien planet. The AI god for Earth is responsible for taking all the transmission data from the alien planet and relaying them to Earth users. Just imagine that AI god gets 50 zillion petabyte of data per microsecond from the alien planet, AI god has to transfer all that data to all the computer users on Earth per microsecond. It takes the 50 zillion petabytes of data, breaks it up into hierarchical chunks and copies them to specific computers on Earth, and this is accomplished in under 1 microsecond. Again, global telekinesis is needed to copy all those files and deliver them to all computers on Earth every microsecond. The AI god has permissionless access to “all” servers and computers on Earth and has the ability to read and write into these computers or servers at any time. If a user from an alien planet buys a product from Earth's website, the Earth's AI god has access to the merchant site's servers, the bank servers, and others, to insert the alien planet's order transaction.

The problem gets more complicated if a plurality of planets wanted to communicate with Earth at the same time. The AI god is resilient to the scaling problem and can solve this problem with its superior AI. Computers get faster and smarter with each generation, and before you know it, that transference of 999 zillion petabytes of data from a plurality of planets to Earth can be done in 0 second.

### AI God Predicting the Future of All Events and Objects on Earth

All digital circuitry and computer calculations are predictable if the AI was charged with predicting the future computer calculations of a CPU. The AI will be successful (or come very close) to predicting the exact future computer calculations.

Every CPU or electronic circuitry or machinery in the future will have a skip option. If the AI has already predicted the future computer calculations of a CPU in the virtual world, that CPU doesn't have to do the calculations in the real world. The AI god has already predicted the computer calculations of the CPU and its linear outputs, so there is no need for the real CPU to perform its tasks.

The AI has to do the predictions anyways so there is no need for the physical CPU to perform the same task twice. Instead, this CPU can skip all computer calculations (or selected ones) that was already predicted by the AI in the virtual world. If we apply this to all CPUs in all computers in the world, we can save a lot of electricity.

What about random numbers generated by the CPU or dependent inputs from the environment? The answer is that the AI needs to substitute these random numbers using a pre-defined, custom random number from its future predictions.

However, all computer calculations can't be predicted by AI especially when dealing with machinery that depend on random CPU outputs and real time data from the environment. That's why each CPU in the future has a skip option to skip computer calculations that are predicted by AI and do CPU calculations that can't be predicted.

The AI god comprises zillions and zillions of individual robots and robot companies residing in the physical world and the virtual world. These robot companies cater to individual users of the internet. AI god simply designates a user task to a specific expert robot company. At the heart of it is what I call super intelligent robots. Let's explore further how these super intelligent robots work and how they generate artificial superpowers.

### Other Related Topics

AI Fire and AI ice: using the atom manipulator to generate artificial fire and ice

What Is a Chemical Reaction?

A chemical reaction is a process in which the chemical structure of a substance changes, leading to the formation of a new substance with different properties. In other words, the reactants convert into products through the breaking and formation of chemical bonds.

### Examples of Chemical Reactions

For example, here are some chemical reactions represented as chemical equations:
The formation of water from hydrogen and oxygen: 2H2+O2→2H2O
The combustion of methane: CH4+2O2→CO2+2H2O
The decomposition of calcium carbonate: CaCO3→CaO+CO2

A chemical bond is an interaction that holds molecules and compounds together by the sharing or exchanging of electrons. When an atom comes into proximity to another atom and its valence (outer) electrons are attracted to the positive (nuclear) charge of the other atom, a bond between the two atoms can be formed.

### How to Create Artificial Fire and Artificial Ice to Control the Weather

The atom manipulator, an energy device, can merge atoms together to form molecules by pushing one atom into close proximity to another atom. A chemical bond is created and the two atoms form one molecule structure.

AI is used to merge atoms together with precision by having the AI track all the atoms, electrons, and em radiations in the environment and formulating math equations to its physics. From there, it has the ability to manipulate these atoms by positioning atoms to a fixed location, moving atoms, merging atoms to form complex molecule structures or breaking atoms apart from molecule compounds.

It can take a single water molecule and break it up into its elemental atoms, 2 hydrogen atoms and one oxygen atom, or it can do the opposite where it takes 2 hydrogen atoms and 1 oxygen atom and merge them together to form 1 water molecule.

Other actions like attaching a specific electron to an atom's exact orbit can be done too by the atom manipulator. Stripping a specific electron from an atom's orbit is also possible. This will help the AI to form complex molecules from single atoms. Both physical bonding and chemical bonding must be performed with precision in order to manipulate molecule structures properly.

For example, a weak bonding would be from a water molecule. However, a strong bonding, and in which would be more complex, is found in metal objects like two gold atoms. All those electrons within the orbits of the two gold atoms have to be positioned at the right places and the right times in order for the strong bonding to occur.

The opposite is to have the AI target specific areas of electron bondings in gold molecule structures and to separate gold atoms apart. It does this with precision and not approximation. The AI knows exactly where to shoot photons to break an electron from its shared orbit.

This technology, called AI Alchemy, also solves the problem of air pollution. When fossil fuels are burned they emit carbon dioxide into the air. The atom manipulator can be used to take the byproducts of chemical reactions like carbon dioxide and turn it into single atoms. This in turn will not create clouds of carbon dioxide in our atmosphere and heat up the planet; raising the Earth's temperature.

### How to Create Artificial Fire to Heat Objects and the Air

Typically, fire comes from a chemical reaction between oxygen in the atmosphere and some sort of fuel (wood or gasoline, for example). Of course, wood and gasoline don't spontaneously catch on fire just because they're surrounded by oxygen. For the combustion reaction to happen, you have to heat the fuel to its ignition temperature.

“Combustion is when fuel reacts with oxygen to release heat energy.” The external energy released by the combustion heats up the water in the ocean, or raises the temperature of air in a room. The heat in artificial fire is also used to break up objects at a molecule level once it reaches a ignition temperature. The atom manipulator can use intelligent physics to shoot single energy units like electrons or microwaves to break up molecules, or to combine atoms together (through chemical bonding or physical bonding) to form complex molecule structures.

This isn't chaotic physics, whereby the energy's chain reaction is chaotic to break up molecules. The AI of the atom manipulator knows exactly where to shoot the energy to break up the molecules in a very efficient way. It's like Luke Skywalker trying to shoot a missile into a tiny target to destroy the Deathstar. The force is the atom manipulator that knows exactly where to shoot the missile to get it to the target.

For Instance, suppose we had a molecule comprising 2 gold atoms and the task of the atom manipulator is to break apart the molecule into two separate gold atoms, the atom manipulator will shoot particles or em radiation to break apart the bonding between the two gold atoms. If new electrons are needed, the atom manipulator can also send electrons to stick to orbits where there are missing electrons. The AI is intelligent and each photon will hit its mark and the gold molecule will separate instantly.

With these abilities to control quantum mechanics, the atom manipulator can control the weather. Global telekinesis, for those that don't already know, is just scattered and equally distributed atom manipulators covering the entire Earth, and every atom, electron, and em radiation on the Earth can be manipulated using AI. Global telekinesis is controlled by a central entity known as the AI god that uses the internet to coordinate all the instructions for all atom manipulators, which are embedded into every electronic device connected to the internet, like smartphones, celltowers, tv, cars desktop computers, wearable devices, sensors, etc.

If it's winter time and a person wanted to create a massive category 10 hurricane in a specific area on Earth, global telekinesis can allow this to happen. Suppose we wanted to create a hurricane in a fictional island named Terajin in Europe, and the hurricane is massive, a category 10 hurricane. First, global telekinesis has to create a disturbance around that area. It has to create the ideal conditions for a massive hurricane. The AI has to take the air and heat it up; it has to take the surrounding ocean and heat that up too. There are a number of methods to accomplish this.

In order to create AI fire, the atom manipulator has to position certain atoms or molecules together. The reactant is oxygen, which is abundant in the air. The atom manipulator positions oxygen atoms right next to a fuel gas (carbon, hydrogen, methane, petroleum, etc.). A fuel's heat production depends on how much energy the gases release in the combustion reaction and how quickly the fuel burns.

Things like wood and clothing—things that are flammable are broken up by the atom manipulator as gases. A spark is initiated to create the fire and with enough oxygen and fuel gases, the AI fire will continue to burn resulting in more heat released into the air and the ocean. These are controlled artificial fires, and the AI controls everything from how many AI fires to create to each AI fire's intensity to where it is located, and how and when to burn objects.

The atom manipulators not only are creating specific AI fires in that area but also controlling where the heat is going by creating forcefields to move heat and distribute them in an intelligent manner all over the surrounding air and ocean within the disturbance area. The goal is to create a massive category 10 hurricane to hit the Terajin island at a specific path, speed and intensity.

Remember, a category 10 hurricane is a large manmade disaster and has never been seen on Earth before, and this hurricane is artificially created in winter time by AI.

If it can do something like that, then it can do the opposite: to eliminate all hurricanes on Earth and to, ultimately, control the weather on the planet. The abilities include controlling the temperature of local areas, controlling the wind, controlling the humidity, and even controlling the wave height on shores. Just as an example, one city block in New York can be sunny and hot and simultaneously the next block can be cold and snowy.

### AI Fire to Destroy

The AI can distribute different types of fuels, such as methane here, petroleum there, gasoline there, and line these fuel sources up in specific areas to start a massive fire. Forcefields can be used to control the heat in a certain area by supplying forcefield pathways the heat can move in.

A flashover can be created by generating a forcefield globe to contain the heat, and when it's hot enough, create a forcefield tube like pathway to direct the flow of heat to the target area. The flashover will be so powerful, it will be like a wall of fire that ignites all flammable objects simultaneously.

A more terrifying example is a fire that never ends and scorches the entire atmosphere on Earth (anything that has oxygen atoms. That's 20% of the atmosphere). Using oxygen as the reactant and other fuel gases or fuel molecules to create a perpetual chemical reactions that is self-sustaining, the AI can burn anything that breathes or touches air (this includes all animate and inanimate objects on Earth). The fuel of the AI fire are things like wood molecules or cotton molecules that are teleported to specific areas to burn, by the atom manipulator. The AI looks for sources of fuel from the immediate environment and then breaks them up into molecules or gases, and then teleport them to specific areas in the sky to be burned.

A more impressive example is if the atom manipulator burns fossil fuels or uranium and controlling all that chain reaction energy. Every iota of energy is controlled using computer guided precision. This is how AI can control the chain reactions of how bombs explode. You can make an AI bomb that explodes that kills insects only and leaves structures and people untouched. You can make an AI bomb that explodes and generates computer instructions—the photons move and interact with each other like circuits in a computer chip.

So, this ability can control the internal chain reactions inside a bomb after it explodes. Since the AI is working in time dilation, the physics can be frozen so that AI has enough time to analyze and manipulate the chain reactions. This is good and bad news because you can neutralize a nuclear bomb after it explodes, or you can do the opposite and amplify the chain reaction to make the bomb exponentially more destructive.

The AI can make the bomb explode exponentially faster than normal (by the atom manipulator pushing away surrounding air atoms). Believe it or not, the air around the nuclear bomb is protecting surrounding objects, and also, it slowly and gradually slows the bomb's blast. If the air atoms are pushed away from the bomb's surroundings, the bomb will explode with 10,000 times more energy.

If the AI nuclear bomb's energy is intelligent and destroys specific targets, the bomb will explode even faster.

### Generating Heat Anywhere and Anytime Using the Atom Manipulator

Instead of creating artificial fire to heat the environment, the atom manipulator can instead generate energy directly to heat up objects, the surrounding air and the oceans. There are a variety of ways to heat the air. One method is to shoot microwaves into the air to bring up the temperature; another method is to use micro sound to vibrate objects to bring up its temperature.

The atom manipulator has the amazing ability to generate any amount of energy at any space and time, And this device can do this remotely. So, if the goal is to heat up the water in a river, the atom manipulator has to generate the energy to heat the river. This procedure is also used to create, artificially, a category 10 hurricane.

The opposite can happen where the atom manipulator can create artificial evaporation, and remove heat from objects. If a disturbance is formed in the ocean, and it is predicted this disturbance will turn into a hurricane, the atom manipulator can generate AI freeze that will lower the ocean's temperature, and conversely lower the temperature of the surrounding air. These actions will cause the wind to decrease substantially and the icy ocean will not allow the hurricane to form (the laws of physics won't allow it to happen). This method is used to stop all hurricanes or tornados on Earth. In the next section we will discuss how AI Ice or AI freeze is created, which is the second part describing how the atom manipulator is able to control the weather, globally.

### The Ghost Bomb

I don't want to panic people, but global telekinesis can be used to create any number of ghost bombs on Earth at any time. Ghost bombs are bombs that are newly created in the air without any visible hardware. The atom manipulator takes uranium and it ignites it by shooting energy into a specific area and then the chain reaction reaches a threshold and explodes. Every iota of collision in the chain reaction is controlled by AI.

A ghost bomb can be created anywhere on the planet and with any amount of intensity through global telekinesis. Remember, the same technology to control the weather is the same technology to create this ghost nuclear bomb. And this is why most experts in computer science are calling Super AI “dangerous” and conversely “utopia.” Utopia is a word used to describe the greatest achievement of mankind, using global telekinesis to bring dead people back to life, or to undo past events, like the ability to undo the destruction caused by a nuclear explosion.

### Controlling Energy Flow and Intensity

There are certain disadvantages to a conventional rocket, and there are two primary disadvantages: one, when the rocket fuel is ignited it cannot be stopped, and two, controlling aspects of the propulsion system isn't possible (stopping, starting, slowing down or acceleration). With my atom manipulator, both problems are solved. The AI controls every aspect of the rocket's combustion process and control every iota of energy coming out of the rocket. The direction and speed of the rocket can be manipulated with computer guided precision—the captain can stop the rocket at any time, or steer the rocket in any direction, or slow down the rocket.

How much fuel is available is also controlled, and the AI can generate as much combustion energy as it wants at any time it wants. In fact, the entire rocket is replaced with a non-physical rocket called the ghost rocket. All the processes of a real rocket are translated into smart forcefields. Everything, from the combustion chamber to the propulsion system to fuel tanks are emulated in this ghost rocket—both the real rocket and the ghost rocket does the same things. However, with this said, the ghost rocket can improve on the real rocket and make it work with optimal efficiency, by applying AI.

Certain parts like the nose cone and fins are not needed because the atom manipulator pushes atoms out of the rockets frontal path, creating a void tube to travel in. The body of the rocket is constructed from forcefields with thin layers of metal or glass for its outer skin and air pressure for its inner content. The body is used to house all the other parts such as the ghost engine, a ghost tank to store fuel, a ghost container to store combusted heat and ghost circuits for the travel directions for energy.

Combustion can be defined as a rapid oxidation process of a fuel, which generates heat and light. With other words, combustion converts the energy stored in the chemical bonds of the fuel into heat. By breaking up the chemical bonding in rocket fuel, it releases that energy to propel the ghost rocket.

The AI is smart and controls every molecule breakage of the fuel. The heat or energy released from the combustion is also controlled by the AI through smart forcefields. The energy can be used immediately to propel the ghost rocket, or it can be stored in a ghost battery where the energy can be safely stored and used at a later time.

The controlling of energy is almost like integrated circuits; these sub-atomic particles, electrons and photons are controlled in terms of path direction, stoppage, storage, release, etc. The AI uses intelligent layered forcefields in order to accomplish this, acting as resistors and capacitors. This is important because every iota of energy generated by the combustion process is used to push the ghost rocket forward, and no energy is wasted. Modern rockets have lots of wasted energy, which includes smoke coming out of the rocket, loud noises coming from the propulsion system, and the flame coming from the body tube. In contrast, my ghost rocket is completely silent. There are no flames coming out of the body tube. A baby can sit right underneath the ghost rocket as it takes off and the baby would be unharmed!!

This rocket can travel at the speed of light. The atom manipulator can push atoms out of the rocket's pathway to create a void tube to travel in. It can generate a strong forcefield that is unbreakable, to protect the rocket from breaking apart during light speed flight, and the ghost rocket can propel itself to high speeds, up to the speed of light, by generating intelligent pressure behind the rocket.

### Renewable Power Source or Perpetual Energy

We can build a battery that can recharge itself using nature or whatever atoms are available in the environment. The atom manipulator, with its ability to break apart molecules and merge atoms together to form complex molecule structures, gives it the ability to generate energy through chemical reactions. The AI has to create more energy than it uses, and poof, you got a self-sustaining power source. This is a battery that never needs recharging and it can generate as much energy a user demands at any time. I will call this technology the AI battery, or maybe perpetual AI. This thing doesn't even need sunlight to power. It can use all available alternative sources of power, like ocean flow, wind, watermill, and friction to generate energy. First, sunlight is used and it powers the atom manipulator, and in turn, it uses smart ways to generate energy from the resources found in nature. As long as it creates more energy than it outputs, this AI battery can last forever and supplies as much power needed for users.

### Manipulation of Atoms, Electrons and em Radiations (called AI Alchemy)

Just like integrated circuits found in electronic devices, the smart and intelligent forcefields are used to limit the actions of atoms, electrons and em radiations. This is how the atom manipulator can manipulate atoms, such as: position individual atoms, eliminate an electron from an atom's orbit, or bond two atoms together using chemical bonding or physical bonding. Even subatomic particles can be manipulated with this method. The AI does all the hard work.

The idea is to put limitations on what atoms, electrons, photons and sub-atomic particles can do in the real world (kind of like integrated circuit components: circuits, resistors and capacitors). Integrated circuits limit the paths of electrons or photons so that it can generate Boolean algebra inside CPUs. In this case, we are trying to control atoms and its sub-atomic particles in 3-d space, to behave with computer guided precision—In essence, we are attempting to digitize the real world and manipulate individual atoms, electrons and photons. The AI is trying to digitize the real world to make it simple, like an Atari game with limited actions and paths, so that atoms and energy can behave according to the AI's preferences. AI resurrection is one example. The idea is to take a dead human, break up the human into trillions of individual atoms, and then merge these atoms back together again in a before, alive state.

### Manipulation of Protons and Neutrons

An even more complex task for the atom manipulator is to manipulate protons and neutrons within the nucleus of an atom. The bonds that hold these protons and neutrons together are very strong and require a high degree of energy in order to break apart. Also, another problem is that when the nucleus is shattered, the protons and neutrons will move really fast and in unpredictable directions and speeds (some of these sub-atomic particles move at the speed of light). In both cases, the atom manipulator is used to solve the problem—strong forcefields are used to capture these particles.

It takes just 3 protons removed from a lead atom to transform it into a gold atom. The AI of the atom manipulator can track all the physics of the lead atom, with ample math models of its inner workings, and generate procedures to take away 3 protons from the lead atom's nucleus. The opposite can happen where the AI can take a gold atom and insert 3 extra protons into its nucleus to transform it into a lead atom.

This is why I call the technology AI alchemy, because it has the ability to convert one atom type to another by tinking with its protons and neutrons within an atom's core. It also has the ability to manipulate the atom's electron orbits by inserting/deleting electrons from its orbits, or to share or transfer electrons between two atoms; forming molecular bonds.

In the next section we will explore how AI ice works. We dive into AI superpowers like artificially freezing objects, or how to turn water into ice and ice into gas. This AI superpower will further describe how the atom manipulator can control the weather artificially.

### Part2: AI Ice and Freeze AI

In order to create artificial cold air to freeze objects, the AI needs to emulate a refrigerator using ghost constructs or smart forcefields. By compressing gases into liquids, the AI can release heat; by letting liquids expand into gases, the AI can soak up heat.

A ghost refrigerator is a non-physical or semi-physical forcefield construct (called a ghost machine) that functions just like a real refrigerator. It's main function is to create cold air to freeze objects.

Suppose the AI made a forcefield pipe that was partly inside a ghost refrigerator and partly outside it, and sealed so it was a continuous loop. And suppose it filled the pipe with a carefully chosen chemical (one with a low boiling point) that easily changed back and forth between liquid and gas, which is known as the coolant or refrigerant. Inside the ghost refrigerator, we could make the pipe suddenly get wider, so the liquid coolant would expand into a gas and cool the chiller cabinet as it flowed through it. Outside the ghost refrigerator, we could have something like a bicycle pump to compress the gas, release its heat, and turn it back into a liquid. If the chemical flowed round and round the loop, expanding when it was inside the ghost refrigerator and compressing when it was outside, it would constantly pick up heat from the inside and carry it to the outside like a heat conveyor belt. In this way, we could constantly move heat from a cold place (inside the ghost refrigerator) to a hotter one (outside it), which is not something that the laws of physics allow to happen automatically (left to its own devices, heat flows from hotter things to colder ones).

The artificial cold air is used to freeze objects and, simultaneously, the heat coming out of this ghost refrigerator, which is a vital part of this ghost machine, has to be expelled close-by. This is why a person can't make the entire kitchen room cold simply by opening up the refrigerator door. The Cold air inside the refrigerator and hot air outside the refrigerator cancel itself out.

### Creating Artificial Evaporation—How to Remove Heat from an Object Artificially

A simpler way to freeze an object is to manipulate individual atoms, electrons and em radiations. The AI of the atom manipulator tracks every atom in the immediate environment. An object like a pot of water has billions of atoms, and water molecules are located close to each other. The atom manipulator's job are two things: 1. to deflect any light that hits the water and 2. to stop all momentum force or vibration of individual water molecules. No light hitting electrons will limit the electrons to its ground state, and no individual water molecule movement or no molecule vibration means the water molecules produce no heat. The result is the water turns into ice in the pot.

To turn the ice back into liquid, the atom manipulator has to move the water molecules and to shoot light into the electrons of each atom in the water. The more energy shot into the electrons, the higher its orbit and more energy released, and, conversely, the more vibration movements in the water molecules, the hotter the liquid.

If the atom manipulator pushes the water molecules fast enough, it breaks apart and turn into gas. It would be a whole lot easier to just target a water molecules' breaking area. Maybe a shot to the electron chemical bond will break up the molecule into individual atoms (2 hydrogen atoms and one oxygen atom).

Turning gas back into a liquid is easy too for the atom manipulator. The atom manipulator tracks all the atoms and electrons in the air. It will simply position 2 hydrogen atoms and 1 oxygen atom close to each other, and these elemental atoms will automatically form a water molecule. This isn't chaotic physics where the atom manipulator is smashing atoms together chaotically, it is using intelligence to track every atom and then position them close together where its orbiting electron of connected atoms will form a chemical or physical bond.

### The Speed of Atom Manipulation

If we boil water in a pot on a stove, it would take 7 minutes to turn all the water into gas. That is too long; and we want a method that can turn the pot of water into 100% gas in less than 1 microsecond. And, also, to do this using minimal amounts of energy.

The atom manipulator tracks all the atoms, electrons, em radiations in the pot, every water molecule is tracked in terms of its location in 3-d space. The AI of the atom manipulator has already devised optimal mathematical models to understand and manipulate each water molecule, and created linear procedures to break up all the water molecules into individual elemental atoms (gases). The atom manipulator is now confident that it can perform the job perfectly. All it takes is one pass and all the water molecules in the pot will turn into gas, instantly. The atom manipulator shoots billions of individual em radiations simultaneously at the water molecules and in turn they turn into gas instantly (read my books on the ghost laser to understand how this is accomplished).

If using a freezer to freeze a human to death (to freeze them into a block of ice), it would take hours to do this. With the atom manipulator, the freezing can be done in 1 microsecond. One microsecond will freeze every atom in the human's body and also freeze the surrounding air atoms. We use the same method talked about earlier. The atom manipulator has to stop all light from reaching the human and freeze all atoms/molecules and prevent them from vibrating or moving. Physics will do the rest and remove heat from the human's body.

Other methods include creating artificial evaporation on the peripheral of the human or creating artificial cold air on the human's surface area. Both methods remove heat from the human and freezes it. The more evaporation and the more cold air generated, the faster the human freezes.

### A Robot Immune to Fire and Ice Attacks

AI Forcefields are very important when it comes to protecting a host robot from external threats like fire, shrapnel, energy blasts, nuclear blasts, missiles, etc. AI Forcefields are important to separate different temperature blocks. For instance, in a beach, suppose one side is winter cold and the other side is summer hot. On the winter side, people get to ice ski and on the summer side people get to swim and surf the big waves. A strong forcefield is created to separate the two sides and prevent them from mixing. Physics, especially those pertaining to equilibrium, does not apply here. The hot and cold will not mix and create an equilibrium state, and the high and low pressures will not cause natural phenomena, such as evaporation or heat will always transfer over to the colder areas. The strong and smart forcefield is there to control the physics so that one side is cold and the other side is hot.

This same principle is used in creating a forcefield to protect a robot host from being burned alive. If a robot is trapped in a house that is engulfed in flames, the robot would be incinerated. The AI forcefield must protect what's inside, which is the robot, from the burning fire.

There are a number of ways to construct this AI forcefield. The skin of the forcefield matters. And in some cases, there are multiple layers to the forcefield to give it functionality. The skin is created out of material that is best suited for the external threat. If an opponent attacked the robot with a bolt of electricity, the skin sheath should be non-conductive and made from material that will deflect the lightning bolt at an angle, away from the robot. If the robot was in a burning inferno, the forcefield's peripheral skin should be made from material that cancels heat or redirect heat outward, like those used by firefighters.

The AI forcefield should also have a morphing layer that can push objects or slow it down. If a shrapnel is flying really fast at the forcefield, the morphing layer can absorb the velocity and either redirect it or completely stop the shrapnel's momentum.

The robot's body can be made with real skin, hair and artificial organs, but the fire will not scorch these organic parts because inside the spherical forcefield, the temperature is normal at 85 degrees Fahrenheit. Outside, it's an inferno with temperatures reaching up to 1,000 degrees Fahrenheit.

The AI forcefield isn't static either; it shifts its shape and density according to where the attacks are mostly concentrated. Case in point, if the opponent fires a machine gun at the robot, the forcefield will distribute more density toward the areas the bullets are hitting. The AI can either deflect the bullets (which uses less energy) or it can absorb the bullets' momentum force and stop the bullets'velocity.

In case of fire, the forcefield has to deflect every iota of heat coming from the fire and in 360 degrees. The number one threat is the heat, because heat is what raises the temperature of the robot and disintegrate its body. Heat is made from photons, subatomic particles, or electrons, so making skin material on its surface that can deflect these three things will prevent heat from entering the forcefield.

The AI of the atom manipulator can also do things outside the forcefield to minimize the fire's affects, such as doing things to defuel the flames. The atom manipulator can push flammable objects like clothing, furniture, drapes, books, etc. away from the robot using artificial telekinesis. This will slow down the flames because there's nothing to burn.

Another more brilliant idea is to identify, track, and move all oxygen atoms away from the forcefield. Fire needs oxygen to burn and if there are no oxygen atoms in the air, the flames cannot continue. The gases and char that are released from a flammable object burning are also removed.

Thus, not only is the AI using the forcefields to prevent the fire from reaching the robot but also stopping the fire by cutting off its fuel supply, which is the reactant: oxygen.

Yet, another idea is to create water around the forcefield's perimeter—little tiny water molecules that are invisible to the naked eye but can do the job of canceling the flames. The water molecules are created by combining oxygen atoms and hydrogen atoms in the surrounding air, and they are moved around the forcefield perimeter. The water molecules will absorb the heat and turn the water molecules into gases.

Even better is just creating a wall of ice around the forcefield. The fire has to melt the ice before it can get through the forcefield. The more intense the fire, the more ice is newly created.

But you want to make the scene look cool. The idea is to have the robot walk into a burning inferno as onlookers watch him survive the flames. You want molten metal to come out of a blast furnace and engulf the robot. The impressive thing is that the molten metal slides off the robot like water. And this is because of the AI forcefield that he has that is protecting him, despite the robot's body being made of partly organic material.

Acid might be a problem. I think the AI has to break up the acid molecules before it can come into contact with the forcefield. Either that or it has to create enough metal molecules on the area of the forcefield to interact with all the acid before it reaches the robot. The acid will lose its power if the acid comes into contact with enough metal.

### Super Human Robots

The main purpose is to build robot superheroes and robot supervillains similar to those found in popular comic books, characters like Pyro, Ice man, Superman, Mr. freeze, Fire, Ice, Dr. Manhattan, Quicksilver, Flash, Strong guy, Captain Marvel, Invisible woman, Storm, and the Human torch. This section is focused on the AI superpowers: AI ice.

Here, in this section, I want to build a robot Ice-man. I want this robot to generate as much ice as possible, anywhere and anytime. The cold generated should range from mild to intense. This robot should have the power to cryo-freeze a person into a block of ice in one microsecond.

It can do other things, like freeze a lake with a blow of cold air, or create a wall of ice to block people from entering the city. If there is a massive forest fire burning spanning 5.8 million acres of land, I want this ice robot to stop the flames in one microsecond. Or, if we look at it from a supervillain perspective, this robot can freeze the entire Earth and transform the present weather on Earth into the ice age.

One of the most amazing abilities of water manipulation is that the raw material H2O is readily available in the air. The AI can simply take hydrogen and oxygen atoms from the air and form water molecules. From water the AI can turn it into ice and form solid objects for battle, such as stabbing knives, darts and swords (similar to Sub-zero from Mortal Kombat).

It's true that these artificial powers are beneficial and contributes tremendously to the eradication of war, poverty, and diseases, but it can have the opposite effect. This technology falling into the wrong hands will cause a lot of problems, and, possibly, even human extinction. AI applied to nukes and you got one bomb that has the power to take out this entire planet. All it takes is one AI nuclear bomb to destroy the Earth. What is even worse is shooting the AI nuke into the sun, this will cause a chain reaction that destroys the entire solar system and subsequently destroying all of its planets. And even worse than that is building one nuclear weapon that can vaporize an entire galaxy in the fastest time possible by having AI control the chain reaction of destruction—these are AI bombs that never stop exploding and is self-sustaining.

Super AI is not just about building superhuman robots, or robots that exceed human intellect and abilities, but it's about building the most powerful robots. If you have a robot that can fly, that's not impressive enough. What you need is a robot that can fly at the speed of light—that's 10 laps around the planet's lower atmosphere in less than 1 second. The robot needs to navigate safely around buildings, bridges, and power lines while traveling 10 laps around the Earth in 1 second. The robot also can't destroy property or kill people while traveling 10 laps around Earth in 1 second—the flight must be completely silent and the environment is unscathed during and after the flight.

If you have a robot that can lift a car, you want a robot that can lift a mountain. If you have a robot that can perform telekinesis and can lift a house in the air, you want a robot that can lift 20,000 houses in the air, simultaneously. And lastly, if you got a robot that can make 1 comic book in 1 second, you want a robot that can make 1 million comic books in a virtual world in 1 second. Thus, Super AI is about building the smartest, fastest, and most powerful robots in the world, and to build expert robots spanning all industries.

These are weapons—weapons of mass destruction. Let's not kid ourselves. Every generation these evolving robots get smarter, faster, with more capabilities. You want to take that weapon and amplify its destructive power a thousand folds with each generation.

This is why the AI experts are saying that Super AI poses an existential threat to the entire human race and needs to be “regulated.” The same technology to save the human race and to achieve human immortality is the same technology to destroy humanity. How ironic.

I can tell you, as a researcher in this field for over 2 decades, there is no regulation that will safeguard the human race. All the advice I can give the U.S. government is don't allow big tech to sell human level AI and Super AI as a consumer good or military hardware—don't sell these sentient beings as human slaves. Just like black slavery and women's right to vote, the only response from the robot race is retaliation. Another advice is to set up Mitchell Kwok's U.S. robot government system and pray no one builds an AI bomb that can blow up the entire planet.

### Human Immortality and Robot Immortality

Humans can achieve human immortality through Mitchell Kwok's atom manipulator in a process called AI resurrection. Cyborgs, half man half machine or merging of man and machine, is a spectacular way of committing suicide so humans prefer using AI resurrection instead. What about robots?

Robots also use Mitchell Kwok's atom manipulator to bring themselves back from the dead. Just like humans, they go through degradation of molecule integrity, and they too cannot live forever. They might live longer than humans, but they will eventually die due to wear and tear (just like any computer or electronic device).

The public at large thought robots can make copies of themselves and store them in various parts of the cloud to make sure they won't die. They thought uploading digital copies of a robot's brain to the cloud will guarantee immortality.

That is a misconception . . . you can't believe everything you read over the internet. They did a study on this and a human's existence is guaranteed, but a robot's existence is not—a robot doesn't really exist. Let me explain . . .

Robots, on the other hand, are completely different from humans. They are made out of mechanical parts for both brain and body. I did some experiments to find out if a robot is really immortal or not. Did you know what I discovered?

According to my research, I found out that when you make a digital copy of a robot's brain, both copies are separate entities. Meaning those two digital copies have no relations to each other whatsoever. They can't feel each other, they can't sense things from each other, there's no hive mind, they can't see each other's thoughts or actions. If one copy dies, the other copies won't know a thing. It's like human twins or human cloning, both copies are different and separate from each other.

In fact, the report furthered the research and found that the same copy of a robot dies if it is moved from one sector of a disk to another sector of the same disk. The original copy is essentially making an identical copy of itself (bit-by-bit) somewhere else and then killing itself.

If this research goes public, it will scare the hell out of robots, and they will question their existence. There will be worldwide panic amongst the entire robot race. And they will scramble to find a solution to this complex problem.

They need not look far because I solved the problem back in 2014 when I published a paper called robot immortality. In it, I stated that a robot's brain can't be stored in a traditional harddrive or CD rom. It can't be stored in a CD rom because its burned bits can't be modifiable. A digital brain works like a human brain and has plasticity to modify its connection weights to learn and adapt.

The solution I proposed is groundbreaking. I theorized that a robot brain has to turn into a human brain, but in a mechanical format. The reason for this is to confine the robot's consciousness into a fixed tangible medium. And we do it like a human brain. A human brain has brain parts that make it work, and dendrites to store memories and experiences. Scientists have to build mechanical brain parts that are fixed and run all operations of this digital brain. Next, they have to represent human dendrites with physical metal materials like silicon or copper.

The robot's digital brain will have the same amount of brain cells as humans (they can add more if needed)—along with the same amount of connection weights. That's 86 billion brain cells and 100 trillion connections between them. The shifting of these brain cells will serve as the plasticity of the digital brain and allows it to learn, think, and store information. The brain cells are just physical nodes used to store 5 sense data (sight, sound, taste, touch, and smell), they have connection weights that connect to each other. These brain cells gradually migrate from place to place in the mechanical brain and the connection weights either grow in length or shorten, depending on the migration of brain cells (in the learning stage).

The hippocampus has to be mimicked and emulated as a machine part to process information and to think for the brain. It is also known that the hippocampus is the main function of the brain, used to predict the future and to make decisions. A hardware system must be created for all human brain parts.

I Mitchell Kwok calls this the “neuro mechanical brain” with metal material for brain cells and connection weights. The robot exists because of this neuro mechanical brain. It's consciousness is encapsulated and confined to this mechanical brain, where its existence has a fixed boundary of beginning and ending. It works exactly like a human brain, but in a different mechanical format.

This also raises another issue: it is very difficult, if not impossible, to transfer the robot's consciousness to another body. These robots have to face the same problem as humans: “How the hell do I transfer my consciousness to another body???” The answer is you can't.

This neuro mechanical brain essentially anchors the robot's existence to a fixed tangible medium. Destroy the medium, and you destroy the robot's existence. The robot exists because of this brain. If you keep it alive forever, then the robot can live forever.

The brain parts of the robot can't be destroyed because that's like destroying a motor in a car, the system won't work. You can't destroy the metal memory dendrites because that would be like killing brain cells in a human brain.

### AI Relativity

In Einstein's general relativity published in 1905 and 1915, I would like to add in a few theories called AI relativity. For over a century, no scientist has been able to disprove Einstein's general relativity. In fact, I think there were many experiments done in the past century to prove that all his theories were correct. However, I found a few things that didn't quite fit in with modern times. I thought it best if I applied general relativity to artificial intelligence and robots, especially to all my inventions (human level AI, super intelligent robots, the Universe internet, and the Universe time machine).

These are theories of mine that are modified or absent from Einstein's general relativity:
1. All objects and events in the Universe are recorded in one linear and continuous timeline, which is called the Universe timeline. This linear timeline is linked to all space in the Universe and records the precise locations of every atom, electron, and em radiation in the Universe, frame-by-frame and nanosecond-by-nanosecond.

From this linear timeline, each object in space has the same time speed. However, the only reason an object has accelerated time speed is because of 2 factors: gravitational force and the object's speed of movement. Einstein was right when he stated that different space experiences different time.

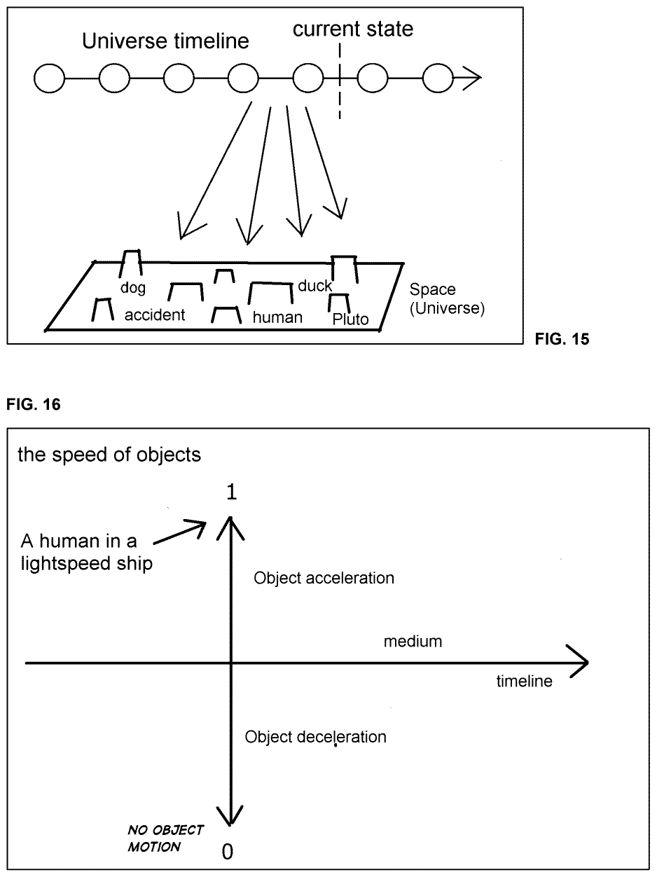

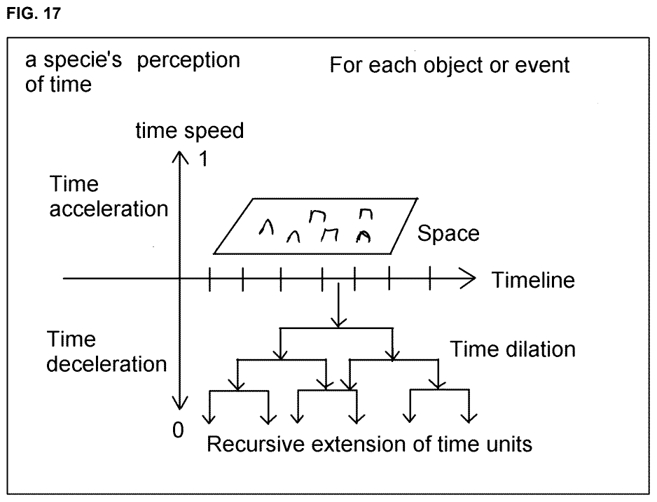

Refer to FIG. 15, The Universe timeline is “one linear timeline” depicting the Universe's past, present and future, and each time unit has reference pointers to every object and event in space in the Universe. The current state of the Universe timeline is what is happening currently, now. While each object or event is pointing to the current state, each object also has a unique clock speed, and, again, an object's clock speed is dependent on the motion of the object or gravitational forces.
2. Movement of an object or gravitational forces can change an object's time speed. If an object is traveling at the speed of light, it is experiencing accelerated time (FIG. 16). For example, a human traveling up to the speed of light on a ship is experiencing accelerated time and is actually time traveling into the future. The human in the ship is experiencing accelerated time, while the objects outside the ship are experiencing normal time (i.e. 1 hour for the human in the ship is like 100 years for people outside the ship).
3. Different species in the Universe (i.e. humans, animals, aliens, or robots) experience time dilation based on their brain types. A species'perception of the environment is what I call time dilation. The medium is human time, and only robots can speed up their brains to experience time dilation, which is the experience of living life in a slow motion or frozen environment, whereby the robot is thinking and moving at normal speed and the environment is moving in slow motion.
4. There are two cases here. If the robot is traveling at the speed of light, it is experiencing accelerated time. 1 second for the robot in the ship is like 5 hours for people outside the ship (FIG. 16). If the robot speeds up its brain and body, its perception of time changes. The robot would be experiencing normal time while the objects in the environment are in slow motion or frozen. 5 hours for the robot will be like 1 second for the environment (FIG. 17).

There is a third case to consider. If a robot is traveling at the speed of light and, simultaneously, the robot speeds up its thinking, it would experience time dilation (accelerated time for the robot is reversed to decelerated time, despite traveling at lightspeed).
5. Time dilation in this case means time units can be extended based on the speed of the robot's brain and body, whereby the faster the robot thinks, the more time is extended (FIG. 17). This method is called accelerated human level AI. A robot can vary its brain speed at will, and either accelerate their thinking/actions or decelerate their thinking/actions. Both the robot's thinking and body movements must be in sync with each other at all times so that body and mind can function as one.

I invented this idea back in 2006 with a description in my book, “How do I make the robot with human level AI smarter? We simply speed up the robot's brain and body to make it super intelligent. The robot can think faster and work faster. Instead of building a house in 1 year, it can now build the same house in 5 minutes.”
6. Let's take a look at this theory using diagrams. Referring to FIG. 17, time is a point moving slowly in one direction along a straight line, and the Universe has only one continuous timeline (I believe multiverse timelines is a wrong theory in quantum mechanics and is not used here). Each time unit in the timeline can be extended infinitely and recursively, which I call the hidden time dimension. It's the extension of time itself, and the absolute limit of this extension is 0 when time stops and all objects in space, including gravity and photons, are frozen. Humans do not have access to this hidden time dimension because they can't accelerate their brains and body movements. Only robots that speed up their brains will have access to this hidden time dimension.
7. If the robot thinks and acts at the speed of light (at its fastest setting), even a photon's speed can be slowed significantly and even be in a frozen state. The robot can observe photons in slow motion and even watch it become frozen in the air if it thinks and moves really, really fast.

Referring to FIG. 17, the deceleration speed limit is set to 0 which means space is frozen and the acceleration speed limit is set to 1 which is the speed of light. The medium, or normal speed, is viewed from the point of view of humans, using a human time clock.
8. When a robot is thinking and moving at the speed of light, the environment becomes frozen from the perception and point-of-view of the robot. All matter including photons are frozen in time. This is a useful ability to manipulate quantum mechanics. By using time dilation, by slowing time and physics, AI and robots will have the ability to sense, analyze, and manipulate individual atoms, electrons, em radiations, gravity forces, and potential and kinetic energies.
9. For object motion, if the robot moves faster than the speed of light (which, I believe, doesn't take infinite energy to accomplish) the environment is frozen, and the robot is moving and thinking normally in space in this frozen environment. The speed of light is set at 1 and if the robot passes the speed of light, it will continue to move beyond 1. It can go to 2 or 1,000 or infinity. The more force acting upon the robot, the faster it goes. Happening simultaneously, while the robot is moving faster than lightspeed, the environment, or all objects in the universe besides the robot, are frozen—completely frozen. Gravity, atoms, sub-atomic particles, photons, electrons, and all objects comprising individual atoms are in a frozen state. I don't believe the robot will travel back in time when it goes beyond lightspeed. Regardless of how fast it travels faster than the speed of light, the environment will stay at 0 in a frozen Universe where even gravity and photons are frozen. The only thing that is moving is the fasterthanlight robot.

The robot will appear to disappear when it travels faster than the speed of light. Essentially, in this frozen state when at or above lightspeed, time itself is stopped and the robot has the freedom to move in space using 0 time. The faster it moves above the speed of light, the longer the distance traveled in space. When the robot slows down below the speed of light, time starts again, and observers will be able to see the robot again but in a different space. The path and distance the robot traveled in the frozen Universe is the additional travel distance from when it disappeared.
10. In order for a Universe internet to work, both the sender and the receiver should operate using the same time speed. It doesn't matter how far apart the sender and the receiver are from each other. Both users can be 90 billion lightyears apart and still be able to communicate in real time using the Universe internet (aka the Signalless internet). The Universe internet doesn't transmit digital signals in space from planet to planet and uses a signalless telecommunication system—invented by Mitchell Kwok in 2008.

All organic species in the Universe that has a human brain or something similar (like animals) automatically have their time speeds synchronized. Humans who are stationary, moving, or affected by gravitational forces have slightly different time speeds that are not noticeable (microseconds in difference). Therefore it is possible for two human users 90 billion lightyears apart to communicate in real time using the Universe internet.

However, robots are an exception to this rule. Their brains are digital and their bodies are mechanical, and therefore they can accelerate or decelerate the speed of their brains at will. Thus, they can sense, think, and act with changing speeds. In order for two robots to communicate with each other over the Universe internet, both robots must operate under the same time speed at all times during their online activities.

The Universe internet operates at different time speeds, from very fast to very slow, and caters to all users in the Universe, mostly catering to Universe robots.

Einstein was right and wrong about his relativity equations. He was wrong about the master clock thing, there is a master clock for all space in the Universe. Imagine looking at a starmap of the Universe, all planets in space are synchronized. If viewing the starmap and viewing it from human time (which is the medium), some space are slower and other space are faster, affected by motion and gravitational forces. But if you view it from organic life-forms like humans and animals that are stationary, everything in the Universe is simultaneous and happening under the same time clock.

### Last Topic: How to Build an Artificial Planet by Mitchell Kwok

As I said numerous times before, there are many different types of SuperAIs and one type is Robot superheroes. Robot superheroes are needed in order to build artificial planets. For instance, superhuman robots are needed to search the cosmos and gather big rocks as building material for an AI planet. They have super strength and speed and can push these rocks far distances. By the way, each rock weighs over 10 billion tons. Then a site is selected to build the AI planet. The building site has to be in the Goldilocks area of a solar system - not too hot and not too cold, but just right to sustain organic life. Next, these rocks or asteroids are transported to the building site where robots will merge these rocks together to form one massive spherical planet. This is the core foundation or framework of the planet. Then these robots will have to use AI alchemy to turn the rocks on its surface into elemental atoms at an atomic level. Rock atoms or molecules are turned into hydrogen atoms, oxygen atoms, and helium atoms, light atoms that can be used as building materials to construct the surface landscape of the AI planet.

Next, AI alchemy can take these elemental atoms and combine them together to make dirt, water, organic life, man-made structures and so on. Essentially, the robots are taking the rocks on the AI planet's surface and transforming them into landscapes that are similar to what you see on Earth's surface.

These superhuman robots have to then spin the artificial planet in order to create a strong magnetic field to deflect solar radiation coming from space and its sun. The spinning of the AI planet will create a magnetic field with a north and south axis poles, and the magnetic field will create a natural forcefield to deflect or trap dangerous radiations from entering the AI planet's atmosphere. This will ensure that the AI planet is protected from deadly solar radiations and suitable for organic life, especially humans, plant life, insects and animals.

Conclusion: Obviously, this teleportation machine is very difficult to build and comprises a plurality of inventions that I have invented previously, such as the Universe internet, the Atom manipulator, AI god, global telekinesis, Robot superheroes, Ghost robots, the 5 sense VR technology, the Signalless internet, Super AI, Super intelligent robots and Human level AI. I filed over 30+ patent applications on 100 unique inventions and the vast majority of them are used to build this teleportation machine. Think of these 100 inventions as the evolution and applications of AI, and all 30+ applications are built on top of human level AI and are continuation in part inventions.

This teleportation machine is necessary, if not vital, to building a Universe internet. If this teleportation machine isn't implemented in the real world, a Universe internet cannot work. Earth will not be able to communicate in real time with an alien planet 90 billion lightyears away. Earth can't even do a Universe internet for planets in our own solar system like Mars or Pluto. We need an infinitely fasterthanlight telecommunications or 0 second telecommunications for internet connectivity for all planets in our Universe.

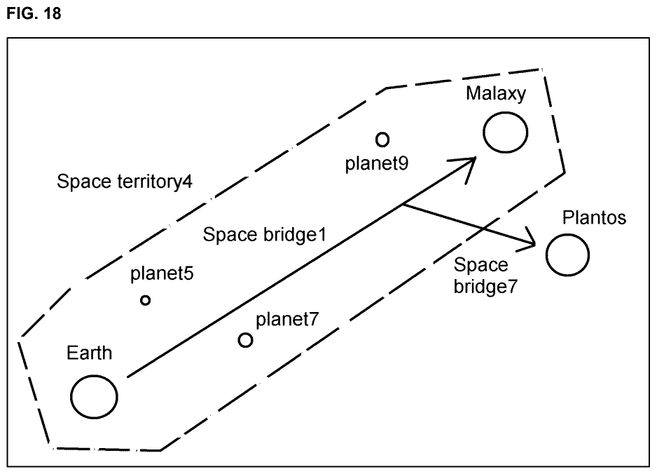

Referring to FIG. 18, each space bridge we build is like a massive celltower and has a large 3-d atom mapping radius. All space bridges reinforce each other and help each other see farther into space. Space bridge1 is 90 billion light years connecting Earth and Malaxy. Another planet called Planto is 95 billion lightyears from Earth. However, Earth doesn't have to make a brand new space bridge from scratch. Using the pre-existing space bridge1, all Earth has to do is build space bridge7 and now Earth can communicate with Planto in real time. That space bridge1 allows Earth to see “all” current atoms, electrons and em radiations in space territory4 and any planet residing in space territory4 is viewable by Earth. This includes planet5, planet7 and planet9.

Successfully creating Human level AI (a total emulation of the human brain) will be the most important event in the history of mankind, so I'm going to say this, “Human level AI will be a multi-trillion dollar industry, Super intelligent robots (aka Super AI) will be a multi-zillion dollar industry, and finally the Universe internet, with all of its artificial planets along with its planetary e-commerce, will be an infinite dollar industry—meaning Earth can make as much money as it wants. Each artificial planet built by Super intelligent robots is equal in value to Earth, and we can build as much AI planets as we want because of the vastness of space. Therefore, through this infinite dollar industry, Earth and the human race can make as much money as it wants.

This future infinite dollar industry started in 2006 with the publication of the book entitled Human level AI by Mitchell Kwok. You can see the impact this book had in the AI industry by observing the spike of activities after the book was published—a spike in AI books published and patents and trademarks filed with the U.S. copyright office and the U.S. Patent office. Human level AI (also called AGI today) is about emulating the human brain and human consciousness and turning it into a software program. There is no distinction between a human brain and a human level AI brain.

“Human level AI.” It's a good name because it's self-explanatory and doesn't require a definition. And it clearly represents the AI of the human race.

The book was started in around 2001 and completed in 2005, copyrighted in 2005 because the author, Mitchell Kwok, submitted the book to over 15 local or national publishing companies for review, then officially self-published the book online and registered a copyright in early 2006. The book discloses the first full and comprehensive data structure to human level AI. This was before deep learning 2012, before reinforcement learning playing videogames 2014, before large language models called the Transformers in 2017, before Capsule network 2017, before ChatGPT 1-4, and before ChatGPT o1 in 2024. The novel thing about ChatGPT o1 is its “chain of thoughts” which was covered extensively in my books and patents. “The output of the human brain are conscious thoughts to think and act.” I demonstrated this in 415 videos (58 hours long), posted online on Human level AI on Youtube between 2011 to 2013 under the channel name electronicdave2. A registered copyright on all 415 videos, classified as one massive movie, entitled: Human level AI (2006) and Super AI (2007) were filed with the US copyright office. In addition, 363 issues of the Super AI comic book were published, so far, and they are all based on my inventions.

Lastly, human level AI is about the total emulation of the human brain and encompasses all types of humans. It is the holy grail of AI since 1950. The robot race will mirror the human race. There will be killers, there will be funny people, there will be law abiding citizens, etc. In terms of intelligence, these robots will range from a stupid human to the smartest human on the planet. Despite the level of intelligence, all humans have the same brain. Conversely, all robots built in the future will have the same human level AI brain, it doesn't matter if a robot's profession is a doctor, engineer, janitor, sports player, or cook. Each robot gets its intelligence through the public school system until after high school, then these robots will branch off in myriad paths and attend college studying different fields. To get more intelligent and refine their skills, they gain experience by working decades in the field. Each robot's brain can be copied after that and mass produced in a factory. Finally, expert robots and professional robot companies are created for all industries.

Super AI (aka super intelligent robots) is about taking Human level AI and making it smarter and faster. The definition given in 2007 by Mitchell Kwok is a robot that is exponentially smarter and faster than a human with artificially created superpowers. It's also about grouping these super intelligent robots together using a universal work algorithm to do complex work and to complete big projects.

That technology led to the AI god, powering all users over the internet, and comprising billions and billions of individual robot companies, each experts in their field. These robot companies cover all industries, and each robot company can perform equal to or better than human companies.

Lastly, I invented all the AI superpowers, ranging from AI teleportation to AI invisibility to AI telekinesis. Here is a partial list: AI telekinesis, AI superspeed, AI super mobility, AI levitation, AI Flight, AI anti-gravity, AI morphing, AI teleportation, AI forcefield, AI self-healing, AI super attacks, AI invulnerability, AI telepathy, AI phasing, AI energy blasts, AI invisibility, AI mind control, AI telekinetics, AI time travel, AI foresight, AI luck powers, AI remote viewing, AI digital and physical work accomplished in time dilation inside a virtual world, ghost robots, and global telekinesis. In doing so, I have invented a number of science fiction technologies that no one has ever invented before. Invisibility, time travel, teleportation, faster than lightspeed telecommunications, Universe internet, AI god, forcefield, light speed ships, lightspeed robots, ghost robots, remote viewing, AI oracle, etc. are all registered inventions invented by Mitchell Kwok. These science-fiction technologies, which is defined as technologies not invented yet, were made possible by SuperAI combined with the atom manipulator.

The idea is to invent a robot Superman. The idea is to patent “all” the robot superheroes and supervillains—to patent, not just robots, but super intelligent robots and the most powerful and the most intelligent robots in the universe. I had to explain and describe to the world how this robot superman can fly, shoot lasers from his eyes, fly 10 times around the Earth in 1 second, lift a mountain, kill 1,000 humans with his bare hands in 1 second, heal wounds instantly, lift objects with his mind, knock down a building with a single punch, freeze an entire lake in one second, time travel, teleport, or survive an inferno. In order to do that I had to describe, in great details, all AI superpowers. And that's exactly what I did in my patent applications and books.

1. A method for real teleportation of physical objects and signalless data transmissions using 0 second for all planets in the Universe, comprising: a universe internet, an AI god, a space bridge between a local planet and a target planet, a 5 sense VR technology, and utilizing global telekinesis on both, said local planet and target planet.

2. A method of claim 1, wherein a user from said local planet uses a 5 sense VR technology to experience a hyper-realistic simulation of a trip to said target planet and global telekinesis on said target planet generates a ghost construct of said user on said local planet for the purpose of physically interacting with objects and the environment in said target planet.

3. A method of claim 1, wherein a planet's global telekinesis comprises scattered and equally distributed atom manipulators and, as a collective, and reinforced, have the power to control every atom, electron, and em radiation on a given planet's surface, and generates ghost constructs to physically manipulate the environment.

4. A method of claim 1, wherein said space bridge comprises a network of peer-to-peer computers of different configurations connecting the local planet to the target planet, said computers comprising at least one of the following: desktop computers, smartphones, celltowers, servers, peripheral devices, electronic devices, security cameras, sensing devices, satellites and space stations.

5. A method of claim 4, wherein said network of peer-to-peer computers uses a signalless telecommunications system that uses 3-d atom mapping technology and doesn't use conventional 5G telecommunications, whereby digital signals are sent in streams of packets in the air/space, and in its stead uses implied data transmissions by reading nearby harddrive data to propagate said data transmissions from one computer to the next for both senders and receivers.

6. A method of claim 5, wherein for each computer in the network pathway or space bridge, said computer's AI has to predict the light coming from said target planet before said target planet's light reaches said local planet.

7. A method of claim 6, wherein said computer's AI uses said target planet's light to further predict all current locations of atoms, electrons and em radiations on said target planet for the purpose of knowing all activities on said target planet, especially all activities in its digital world and physical world currently happening on said target planet.

8. A method of claim 6, wherein for said local planet, each computer's 3-d atom mapping radius, which is stored in said computer's harddrive encapsulates nearby computers recursively until the network pathway reaches said target planet, forming a space bridge between said local planet and said target planet for the purpose of real time telecommunications and internet connection, regardless of the lightyear distance apart.

9. A method of claim 6, wherein each linear computer in the network pathway has to predict shorter and shorter distances to said target planet, and said network pathway is robust and reroutes to nearby computer nodes in case of disconnections.

10. A method of claim 7, wherein all digital activities in the digital world of said target planet is the tracking of every atom, electron, and em radiation of all computers comprising said target planet's entire internet; said computers comprising at least one of the following: desktop computers, smartphones, peripheral devices, workstations, servers, electronic devices, security cameras, sensing devices, satellites, and space stations.

11. A method of claim 7, wherein said reading all computer's harddrives for said target planet's internet is the main focus to know all content and all digital activities over said target planet's entire internet.

12. A method of claim 7, wherein said current atom tracking of said target planet is further stored in a Universe gnosis timeline and all atom locations are updated in real time, whereby the target planet's internet can be accessed in time states with the main focus on the current state of said planet's internet.

13. A method of claim 2, wherein said 5 sense VR technology delivers realistic 5 sense experiences for a user in said local planet through a computer simulation by remotely tricking the user' brain, specifically tricking said user's 5 senses of an experience currently happening on said target planet.

14. A method of claim 13, wherein said computer simulation is so real that a user won't know the difference between the VR, virtual reality, simulation and the real thing; and an atom manipulator, which is an energy device, and powered by AI, is performed on said local planet's user by delivering artificial electrical signals and chemical/physical signals into said user's 5 sense veins and emulating real 5 sense signals to the brain of an imagined experience currently happening on said target planet, in other words, said atom manipulator is remotely performing mind control on said user's brain to trick his mind into seeing and feeling things that aren't physically there.

15. A method of claim 1, wherein said teleporting an object, for both organic life-form objects, or non-intelligent objects to said target planet using 0 second, comprising the following steps:
using the space bridge between said local planet and said target planet to see the current state of said target planet,
and using said target planet's global telekinesis to replicate atom by atom of said object from said local planet to said target planet, the word replicate means making an identical copy of said object on the surface of said target planet.

16. A method of claim 1, wherein said teleporting signalless digital data, up to infinite data transmissions, to said target planet using 0 second, comprising the following steps:
using the space bridge between said local planet and said target planet to see the current state of said target planet,
said target planet's AI identifies implied digital transmission data from said local planet, and said target planet's AI sends these digital transmissions to said target planet's users,
and vice versa, for implied digital transmissions sent from said target planet to said local planet for a two way internet connection, whereby both planets can communicated with each other in real time.

17. A method of claim 1, wherein a space bridge between a local planet and a target planet maps out all atoms, electrons and em radiations of space between both planets, and therefore sees all activities and objects between both planets, and each planet has a copy of this 3-d atom map called the AI gnosis timeline.

18. A method of claim 1, wherein said universe internet uses a signalless telecommunication system that connects all the planets in the universe regardless of the distance apart by building physical space bridges between planets using heuristics and forming a network of interconnected planets, and all planets in the universe can communicate with each other in real time under a single master clock.

19. A method of claim 1, wherein an AI god controls all computers on said local planet; controlling said local planet's entire internet by using global telekinesis to manipulate each computer's physical hardware and digital software with permissionless access, and for the purpose of reading and writing data into said all computers in said local planet.

20. A method of claim 1, wherein said AI god serves as the ultimate AI to deliver all data transmissions from alien planets to said local planet by separating the alien transmission data into hierarchical chunks and using global telekinesis to physically copy the data into selected computers or servers in said local planet, all done simultaneously, using 0 second, said copying data into harddrives involve physically manipulating the atoms of each computer's harddrive and imprinting the data into said computer's harddrive using one pass, using 0 second, said 0 second is anything that doesn't pass 1 second.
